(19) United States
(12) Patent Application Publication
(10) Pub. No.: US 2007/0150930 A1
(43) Pub. Date: Jun. 28, 2007

(54) Device for storing and playing back digital content and method of bookmarking digital content

(76) Inventors: Kyösti Koivisto, Kaarina (FI); Henri Saila, Turku (FI); Kari Muurinen, Vanhalinna (FI); Mauri Kangas, Paimio (FI); Ari Aarnio, Espoo (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(21) Appl. No.: 10/584,879

(22) PCT Filed: Dec. 23, 2004
(86) PCT No.: PCT/IB04/52919

§ 371 Date: Jun. 28, 2006

(30) Foreign Application Priority Data
Dec. 31, 2003 (GB) 0330254.4

(51) Int. Cl. H04N 7/173; H04N 7/16; H04N 7/18

(52) U.S. Cl. 725/134; 725/88; 725/89; 725/81; 725/62

(57) ABSTRACT

A digital receiver has a hard disk drive for storing and playing back digital broadcast content. During playback, the user can mark insert bookmarks. Sections of content can be extracted and stored in a file. Bookmarks and/or extracted content can be transferred to a mobile telephone handset or other digital receiver.

### FIELD OF THE INVENTION

The present invention relates to apparatus for storing and playing back digital content, particularly but not exclusively digital broadcast content, and to a method of bookmarking digital content.

### BACKGROUND ART

EP-A-1351500 describes a digital receiver having a hard disk drive for storing and playing back digital broadcast content. During playback, the user can mark sections for saving to a record file.

### SUMMARY OF THE INVENTION

The present invention seeks to provide a device for storing and playing back digital content.

According to a first aspect of the present invention there is provided a device for storing and playing back digital content, the device being configured to bookmark said content in response to user input and to store at least one, the device also being configured to transmit at least one bookmark to another device.

The device may be configured to identify the user. The device may comprise an interface for establishing connection with the other device via a wireless network and said device is configured to identify the user at least in part by an authentication procedure employed to establish the connection. The device may be configured to store said at least one bookmark in a bookmark file. The device may be configured to receive information for storing in said bookmark file. The device may be configured to store said bookmark file in a bookmark folder. The device may be configured to receive information for storing in said bookmark folder. The information may include information for identifying a user.

The device may be configured to store respective bookmarks associated with two or more points within said content. First and second bookmarks may be configured to mark a beginning and end of a segment of content respectively. The device may be configured to store at least one bookmark associated with point within said content. The device may be configured to bookmark said content in response to user input and to store a first set of bookmarks. The device may be configured to bookmark further said content in response to user input and to store a second set of bookmarks, at least one of said second set of bookmarks being different from said first set of bookmarks. The first set of bookmarks may be attributable to a first user and said second set of bookmarks may be attributable to a second, different user. The first and second set of bookmarks may be labelled with respective information for identifying respective users. The first and second sets of bookmarks may be selectively accessible. The first set of bookmarks may be stored in a first bookmark file and said second set of bookmarks may be stored in a second, different bookmark file. The first bookmark file may be stored in a first bookmark folder and said second bookmark file may be stored in a second, different bookmark folder. The first and second bookmark files may be selectively displayable on a display.

The device may be configured to transmit said first bookmark file to another device and to transmit said second file to yet another, different device. The device may be configured to transmit said first bookmark file to another device via a wireless network.

The device may be configured to store said content in a first content file and to obtain a first set of extracted content from first content file in dependence upon said first set of bookmarks and to obtain a second set of extracted content from said first content file in dependence upon said second set of bookmarks. The first or second set of extracted content may include at least one segment of content between at least one pair of bookmarks. The first set of extracted content may include at least one instant of content at least one bookmark. The first and second sets of extracted content may be selectively accessible. The first set of extracted content may be stored in a first extracted content file and said second set of extracted content may be stored in a second, different extracted content file. The first extracted content file may be stored in a first extracted content folder and said second extracted content file may be stored in a second, different extracted content folder. The first and second extracted content files may be selectively displayable on a display. The device may be configured to transmit said first extracted content file to another device. The device may be configured to transmit said first extracted content file to another device via a wireless network. The device may be configured to keep said first extracted file, even if said first content file is deleted. The device may be configured to receive user instruction regarding extracted content and to provide an assembly of extracted content. The device may be configured to display said at least one bookmark or a representation thereof on a display.

At least one bookmark may be editable. The device may comprise an interface for wirelessly communicating with said other device.

The device may comprise means for receiving digital content, means for receiving instructions to bookmark said digital content, means for bookmarking said digital content, means for storing said digital content, means for storing said at least one bookmark and means for transmitting said at least one bookmark to another device.

According to a second aspect of the present invention there is provided a digital broadcast receiver comprising the device.

According to a second aspect of the present invention there is provided a device for rendering digital content, the device configured to receive digital content and to receive a set of bookmarks relating to said digital content from another device and to selectively render parts of said digital content in dependence said set of bookmarks.

The device may be configured to transmit the set of bookmarks to another device. The device may be s configured to receive said digital content and said set of bookmarks relating to said digital content from the same device. The digital content may be stored in a content file and the device is configured to obtain a set of extracted content from content file in dependence upon said set of bookmarks.

The device may be a mobile communications device and/or a device for storing and playing back digital content. The device may comprise an interface for wirelessly communicating with said other device.

According to a third aspect of the present invention there is provided a method of bookmarking digital content, the method comprising playing digital broadcast content, receiving user input, bookmarking the content in response to the user input storing at least one bookmark and transmitting said bookmark to another device.

According to a fourth aspect of the present invention there is provided a computer program comprising instructions which, when executed by a device for storing and playing digital content, performs the method.

According to a fifth aspect of the present invention there is provided a computer readable medium storing the computer program.

According to a sixth aspect of the present invention there is provided a method of rendering digital broadcast content, the method comprising receiving digital content, receiving a set of bookmarks relating to said digital content, selectively rendering said digital content in dependence said set of bookmarks.

The method may further comprise obtaining extracted content from digital content in dependence upon said set of bookmarks and saving said extracted content in a file.

According to a seventh aspect of the present invention there is provided a computer program comprising instructions which, when executed by a device for digital content, performs the method.

According to an eighth aspect of the present invention there is provided a computer readable medium storing the computer program.

According to a ninth aspect of the invention there is provided a device for storing and playing back digital content, the device being configured to bookmark said digital content in response to user input and to store at least one bookmark, the device also being configured to extract digital content using said at least one bookmark.

According to a tenth aspect of the invention there is provided a device for storing and playing back digital content comprising: means for receiving digital content; means for receiving instructions to bookmark said digital content; means for bookmarking said digital content; means for storing said digital content; means for storing said at least one bookmark; means for extracting digital content using said at least one bookmark; and means for storing said extracted content.

The bookmark may comprise a pointer to within said content, data added to a file storing said content and/or data added to a file other than a file storing said content.

The digital content may be digital broadcast content, such as that received via a digital broadcast network.

A bookmark may comprise a pointer to within said content, data added to a file storing said content and/or data added to a file other than a file storing said content.

According to an eleventh aspect of the invention there is provided a device for storing and playing back digital content, the device being configured to bookmark content in response to user input and to provide at least one bookmark, to extract content in dependence upon said at least one bookmark and to transmit said extracted content.

According to a twelfth aspect of the invention there is provided a device for extracting digital content, the device being configured to receive a file of digital content and a file of bookmarks relating to said digital content, to extract selected digital content in dependence said bookmarks and to save extracted content in file of extracted content.

The device may be further configured to transmit said file of extracted content to another device.

According to a thirteenth aspect of the invention there is provided a portable wireless device configured to co-operate wirelessly with a terminal for receiving digital broadcast content, the device configured to identify a user to the terminal and to transmit instructions to the terminal to bookmark digital content.

According to a fourteenth aspect of the invention there is provided a bookmarking device for digital content, the device comprising a bookmarking engine for bookmarking content in response to user input and for storing at least one bookmark, and means for transmitting at least one bookmark to another device.

The device may further comprise a synchronisation engine for synchronising digital content with said at least one bookmark. The digital content may be stored in a content file. The device may further comprise an extraction engine for extracting selected digital content in dependence upon said at least one bookmark.

### BRIEF DESCRIPTION OF THE DRAWINGS

Embodiments of the present invention will now be described, by way of example, with reference to the accompanying drawings in which:

FIG. 1 is a schematic diagram of a record and playback device, a mobile terminal and a remote control device in accordance with the present invention;

FIG. 2 is a detailed schematic diagram of an embodiment of a record and playback device according to the present invention;

FIG. 3 illustrates functional layers of the record and playback device shown in FIG. 2;

FIG. 4 is a schematic diagram of an embodiment of a mobile terminal according to the present invention;

FIG. 5 illustrates functional layers of the mobile terminal shown in FIG. 4;

FIG. 6 is a schematic diagram of an embodiment of a remote control device;

FIG. 7 is a schematic diagram of a stream of data packets;

FIG. 8 illustrates structure of part of a data packet shown in FIG. 7;

FIG. 9 illustrates structure of another part of a data packet shown in FIG. 7;

FIG. 10 shows a playback file;

FIG. 11 illustrates the remote control device shown in FIG. 6;

FIG. 12 shows changing of a view position;

FIG. 13 illustrates the mobile terminal shown in FIG. 5;

FIG. 14 is a process flow diagram of a method of setting up a record and playback device in accordance with the present invention;

FIG. 15 is a process flow diagram of a method of operating a mobile terminal for setting up a record and playback device in accordance with the present invention;

FIG. 16 illustrates an embodiment of a bookmark file according to the present invention;

FIG. 17 illustrates an embodiment of an extracted content file according to the present invention;

FIG. 18 is a process flow diagram of a method of operating a record and playback device for bookmarking content in accordance with the present invention;

FIG. 19 is a process flow diagram of a method of operating a mobile terminal for bookmarking content in accordance with the present invention;

FIG. 20 is a more detailed process flow diagram of a step shown in FIG. 18;

FIG. 21 illustrates definition of an instant point by inserting two successive start point bookmarks;

FIG. 22 shows definition of a segment by inserting start point and end point bookmarks;

FIG. 23 illustrates definition of an instant point by inserting a start point and quitting bookmarking;

FIG. 24 is a process flow diagram of a method of operating a record and playback device for editing bookmarks in accordance the present invention;

FIG. 25 is a process flow diagram of a method of operating a mobile terminal for editing bookmarks in accordance with the present invention;

FIG. 26 is a process flow diagram of a method of operating a record and playback device for extracting content in accordance the present invention;

FIG. 27 is a process flow diagram of a method of operating a mobile terminal for extracting content in accordance the present invention;

FIG. 28 is a process flow diagram of a method of operating a record and playback device for transmitting files in accordance the present invention;

FIG. 29 is a process flow diagram of a method of operating a mobile terminal for transmitting files in accordance the present invention;

FIG. 30 is a schematic diagram of a record and playback device, a mobile terminal and another record and playback device;

FIG. 31 illustrates storage of the mobile terminal shown in FIG. 30;

FIG. 32 is a process flow diagram of a method of operating a mobile terminal for sending files to another record and playback device in accordance the present invention and

FIG. 33 is a process flow diagram of a method of operating a record and playback device for sending files to another record and playback device in accordance the present invention.

### DETAILED DESCRIPTION OF THE INVENTION

Receiving Content

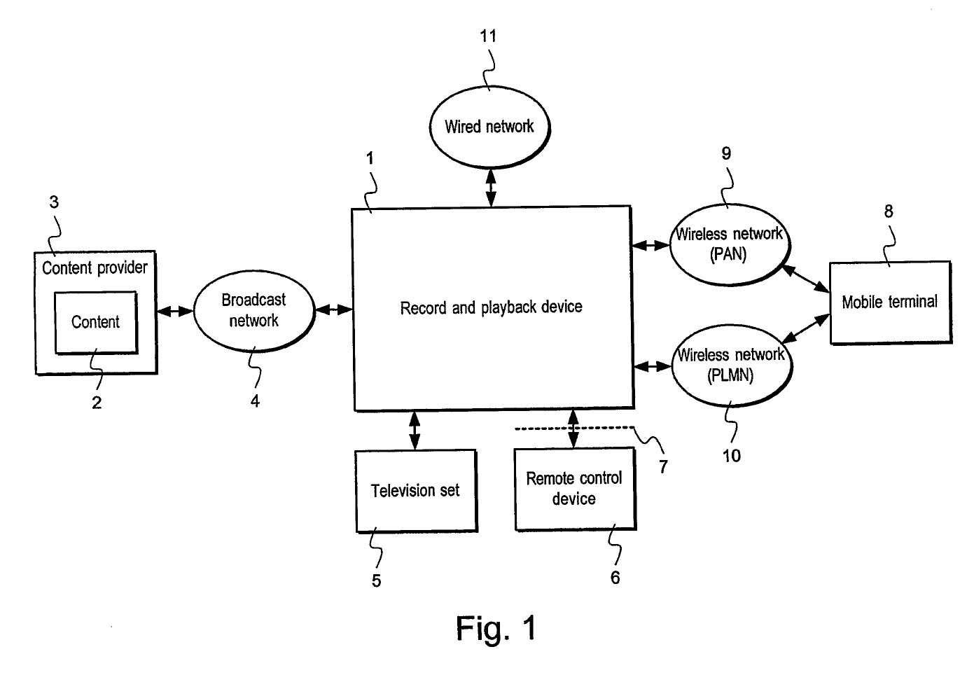

Referring to FIG. 1, a record and playback device 1 receives content 2 from a content provider 3 via a digital broadcast network 4 and renders the content 2 using a television set 5.

The record and playback device 1 is in the form of a module commonly known as a “set-top box”, but may also be referred to as a “personal video recorder” (PVR) or a “personal digital recorder” (PDR). The record and playback device 1 includes receiver functionality. However, different modules may provide receiver functionality and record/playback functionality. The record and playback device 1 may be incorporated into other devices such as a personal computer, mobile communication device or a personal data assistant. The record and playback device 1 having receiver functionality may be incorporated into the television set 5 and such television sets are usually referred to as “integrated television sets”.

The digital broadcast network 4 is in the form of a terrestrial digital video broadcasting (DVB-T), satellite (DVB-S), cable (DVB-C), handheld (DVB-H) or multimedia home platform (DVB-MHP) network. However, the digital broadcast network 4 may be a satellite, cable or other type digital video broadcasting network. The digital broadcast network 4 may be a digital audio broadcasting (DAB) network, Advanced Television Systems Committee (ATSC) network or a terrestrial Integrated Services Digital Broadcasting-Terrestrial (ISDB-T) network.

A remote control device 6 can be used to control the record and playback device 1 via an interface 7, such as an infrared interface. However, other types of interface, such as a low power radio frequency interface (LPRF) may be used. The remote control device 6 may also be used to control the television set 5, such as to switch the television set on and off and to increase and decrease volume.

The record and playback device 1 may additionally or alternatively be controlled by a mobile terminal 8 via a first wireless network 9 and/or a second wireless network 10.

The first wireless network 9 may be a personal area network (PAN) or wireless local area network (WLAN). In this example, the first wireless network 9 is a PAN using a low power radio frequency interface compliant with the Bluetooth™ specification. However, other low power radio frequency networks compliant with other specifications, such as IEEE 802.11b, may be used. However, the first wireless network 9 may use an optical or infrared interface, such as IrDA.

A Bluetooth™ specification (v1.0B) and system overview may be found at www.bluetooth.com or obtained from Bluetooth SIG, c/o Daniel Edlund, Facsimile number +46 70 615 9049. For details relating to WLAN, reference is made to IEEE 802.11 (1999), IEEE 802.11b (1999) and IEEE 802.11b Cor 1 (2001) specifications, copies of which may be obtained from IEEE web-site at standards.ieee.org or from Sales and Marketing, Facsimile number +1 732 981 9334. An IrDA Data specification and system overview may be found at www.irda.org or obtained from the Infrared Data Association (IrDA), Walnut Creek, Calif., USA.

The second wireless network 10 may be a public land mobile network (PLMN). In this example, the second wireless network 10 is a third generation mobile communications network such as a Universal Mobile Telephone System (UMTS) network based on wideband code division multiple access (W-CDMA), or a time division synchronous code division multiple access (TD-SCDMA) network However, the second wireless network 10 may be a “two-and-a-half” generation network, such as General Packet Radio Service (GPRS) network and enhanced data rates for GSM evolution (EDGE).

The record and playback device 1 may additionally be connectable to a wired network 11.

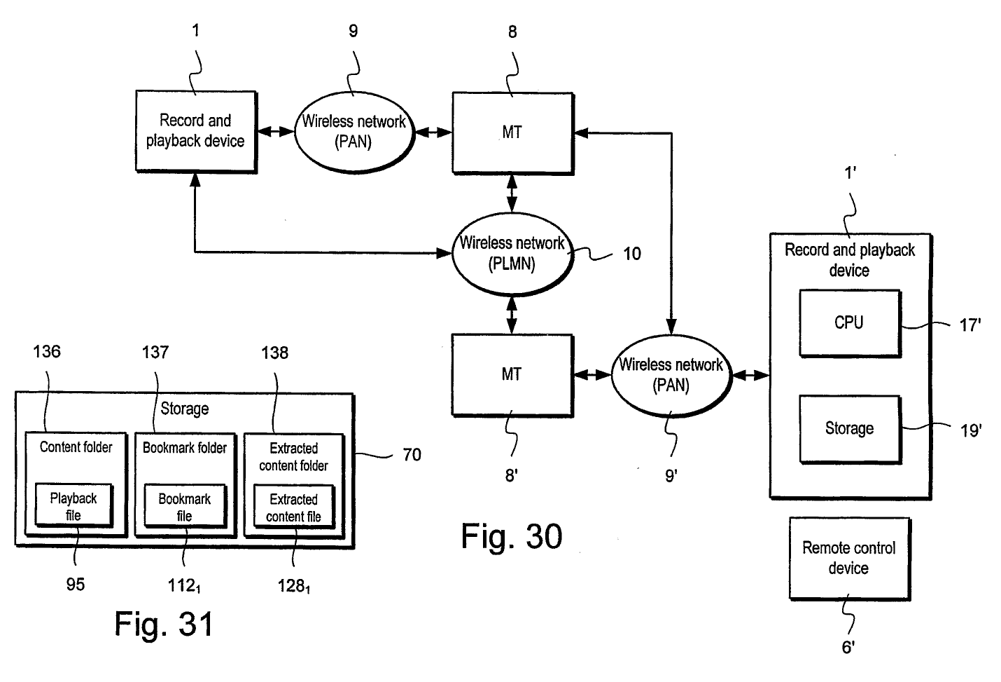

The record and playback device 1 may be connected to the mobile terminal 8, to the content provider 3, to the Internet (not shown), to other content sources (not shown) and/or to other record and playback devices 1′ (FIG. 30) via the wired network 11 or the PLMN wireless network 10.

Record and Playback Device 1

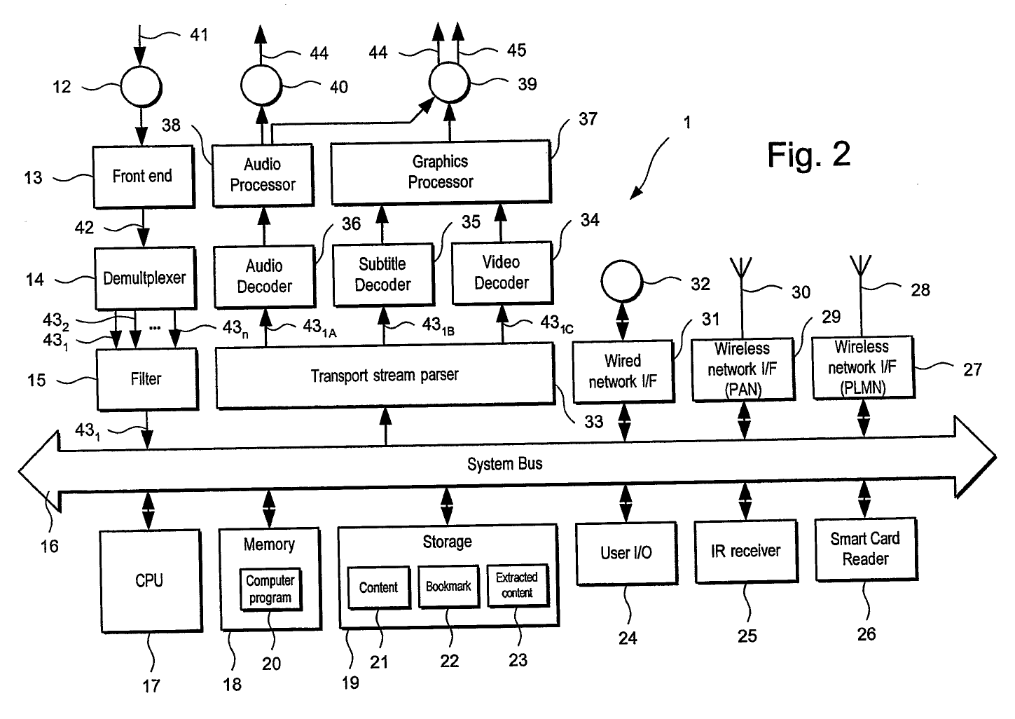

Referring to FIG. 2, the record and playback device 1 is shown in more detail.

The record and playback device 1 includes an input 12, front-end circuitry 13, a demultiplexer 14, a filter 15 and a system bus 16. The front-end circuitry 13 usually includes a tuner (not shown), an analogue-to digital converter (not shown), a demodulator (not shown) and an error correction module (not shown). A descrambler (not shown) may also be included.

The record and playback device 1 includes a central processing unit (CPU) 17, memory 18 and storage 19. At least one computer program 20 is used to control operation of record and playback device 1 illustrated in FIG. 2.

The storage 19 is in the form of a hard disk drive. However, other types of storage can be used, such as an optical disk drive or solid-state memory. The storage 19 may comprise plural devices and may include at least one external, connectable device and/or at least one internal, removable device. The storage 19 has a capacity of 10's or 100's of gigabytes (GB), although it can have smaller or greater capacity. The storage 19 can store, among other things, content 21 including content 2 (FIG. 1), bookmarks 22 and extracted content 23.

The record and playback device 1 also includes a user input/output interface 24, such as control panel having a display (not shown) and a set of buttons (not shown), for allowing a user to control the record and playback device 1 directly, an infrared receiver 25 for receiving signals from the remote control device 6 (FIG. 1) for allowing the user to control the record and playback device 1 remotely, a smart card reader 26 for receiving a smart card (not shown) holding data needed for decrypting signals.

The record and playback device 1 further includes a first wireless network interface 27, in this case a PAN network interface with a corresponding antenna 28, a second wireless network interface 29, in this case a PLMN network interface with a corresponding antenna 30, and a wired network interface 31, in the form of a modem, for sending and receiving signals (not shown) via connector 32.

The record and playback device 1 includes a transport stream parser 33, a video decoder 34, a subtitle decoder 35 and an audio decoder 36, a graphics processor 37 and an audio processor 38.

The record and playback device 1 also includes several interfaces including a connector 39 for providing video and audio signals to the television set 5 (FIG. 1) and an audio connector 40 for providing audio-only signals to audio equipment (not shown). Additional ports may also be provided such as an auxiliary connector for providing signals to a videocassette recorder (not shown) or a data connectors for providing signals to a personal computer.

In use, the front-end circuitry 13 receives a radio frequency signal 41 and produces a stream 42 of data packets. In this example, the data packets are in the form of MPEG-2 encapsulated transport stream (TS) packets. The stream 42 is passed to the demultiplexer 14, which separates the stream 42 into channels 43₁, 43₂, 43ₙ. The channels 43₁, 43₂, 43ₙ include at least one channel 43₁ carrying content 2 (FIG. 1) and at least one channel 43₂ carrying service information. The at least one channel 43₁ carrying content 2 can be selected by filter 15, which places data packets comprised in the channel 43₁ on the system bus 16

The data packets comprised in the channel 43₁ can be directed to storage 19 or to the transport stream parser 33. The transport stream parser 33 divides the data packets 43₁ according to the type of data and forwards divided streams 43_{1A}, 43_{1B}, 43_{1C} to respective decoders 34, 35, 36. The decoders 34, 35, 36 decode and decompress data packets and pass them on to the processors 37, 38 for further processing. Signals 44, 45 from the video and audio processors 37, 38 are fed to the video and audio connectors 39, 40 for transmission to the television set 5 (FIG. 1) and, optionally, additional speakers (not shown).

The CPU 17 controls operation of the record and playback device 1 under instruction of at least one computer program 20. For example, when the record and playback device 1 is switched on, the CPU 17 loads and runs an operating system. The operating system includes device drivers to control hardware devices such as storage 19. Instructions as to how the record and playback device 1 should operate are received from an application run by the CPU 17, loaded from memory 18 or storage 19. In this example, applications are not platform specific. Therefore, additional software, often referred to as “middleware”, is used to help applications and the operating system communicate.

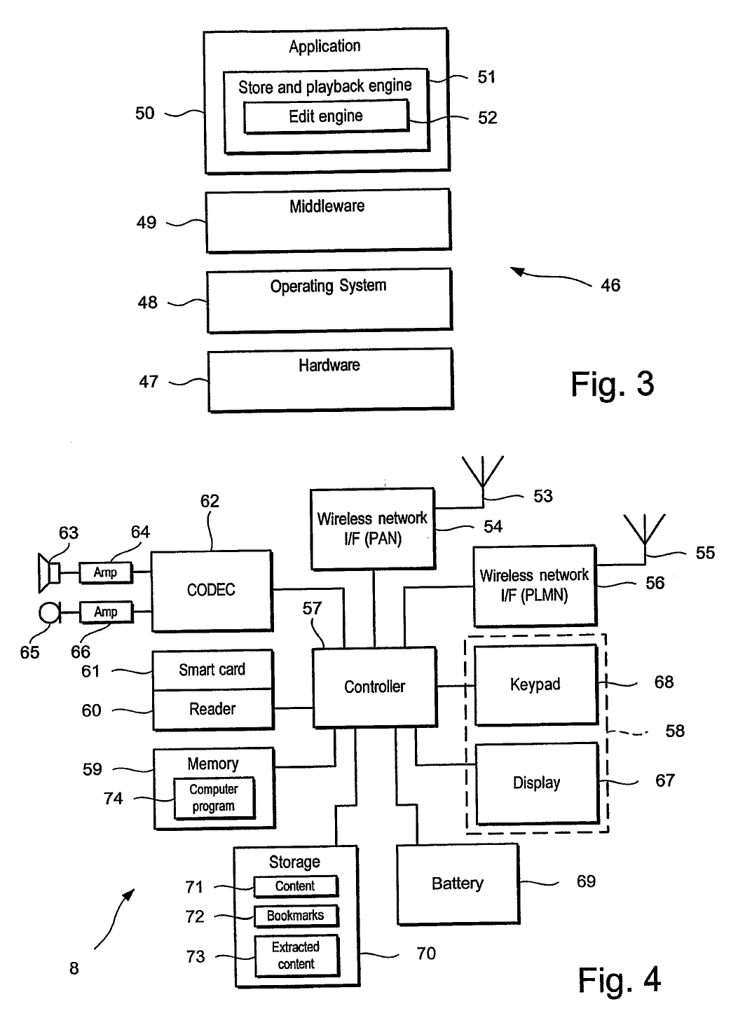

Referring to FIG. 3, a functional layer structure 46 of the record and playback device 1 is shown. The record and playback device 1 uses hardware 47, such as storage 19, an operating system 48, middleware 49 and applications 50. The operating system 48 and the middleware 49 may be combined. In this example, middleware 49 includes a content storing and playing back engine 51 which includes an editing engine 52. The editing engine 52 can be used to create and manage files on storage 19.

Digital broadcasting is preferably performed in accordance with ETSI Standard EN 300 744 “Digital Video Broadcasting (DVB): Framing structure, channel coding and modulation for digital terrestrial television” V.1.1.2 (1997) and related specifications. MPEG-2 encapsulation is described in more detail in MPEG-2 Systems ISO/IEC 13818-1.

Mobile Terminal 8

Referring to FIG. 4, the mobile terminal 8 is shown in more detail.

The mobile terminal 8 includes an antenna 53 and a first wireless network interface 54. The antenna 53 and first wireless network interface 54 are used to transmit and receive signals to and from the first wireless network 9, in this case PAN 9 (FIG. 1). The mobile terminal 8 also includes an antenna 55 and a second wireless network interface 56. The antenna 55 and second wireless network interface 56 are used to transmit and receive signals to and from the second wireless network 10, in this case PLMN 10 (FIG. 1). The wireless network interfaces 54, 56 each include respective r.f. signal processing circuits (not shown) for amplifying and demodulating received signals and respective processors (not shown) for channel decoding and demultiplexing. An additional antenna (not shown) and receiver (not shown) may also be provided for receiving signals from the broadcast network 4 (FIG. 1).

The mobile terminal 8 also includes a controller 57, a user interface 58, memory 59, a smart card reader 60, smart card 61 received in the smart card reader 60, a coder/decoder (codec) 62, a speaker 63 with corresponding amplifier 64 and a microphone 65 with a corresponding pre-amplifier 66.

The user interface 58 comprises a display 67 and a keypad 68. The display 67 is adapted for displaying images and video by, for instance, being larger and/or having greater resolution than a display of conventional mobile telephone and being capable of colour images. The mobile terminal 8 also includes a battery 69.

The mobile terminal 8 also includes storage 70. The storage 70 is in the form of a hard disk drive. However, other types of storage can be used, such as an optical disk drive or solid-state memory or removable smart/memory cards. The storage 70 may comprise plural devices and may include at least one external, connectable device and/or at least one internal, removable device. The storage 70 has a capacity of a few gigabytes, although it can have greater capacity. The storage 70 can store, among other things, content 71, bookmarks 72 and extracted content 73. As will be explained in more detail later, bookmarks 72 and extracted content 73 can include or comprise bookmarks 22 and extracted content 23 transferred from the record and playback device 1 (FIG. 1).

The controller 57 manages operation of the mobile terminal 8 under the direction of computer software 74 stored in memory 59. For example, the controller 57 provides an output for the display 67 and receives inputs from the keypad 68.

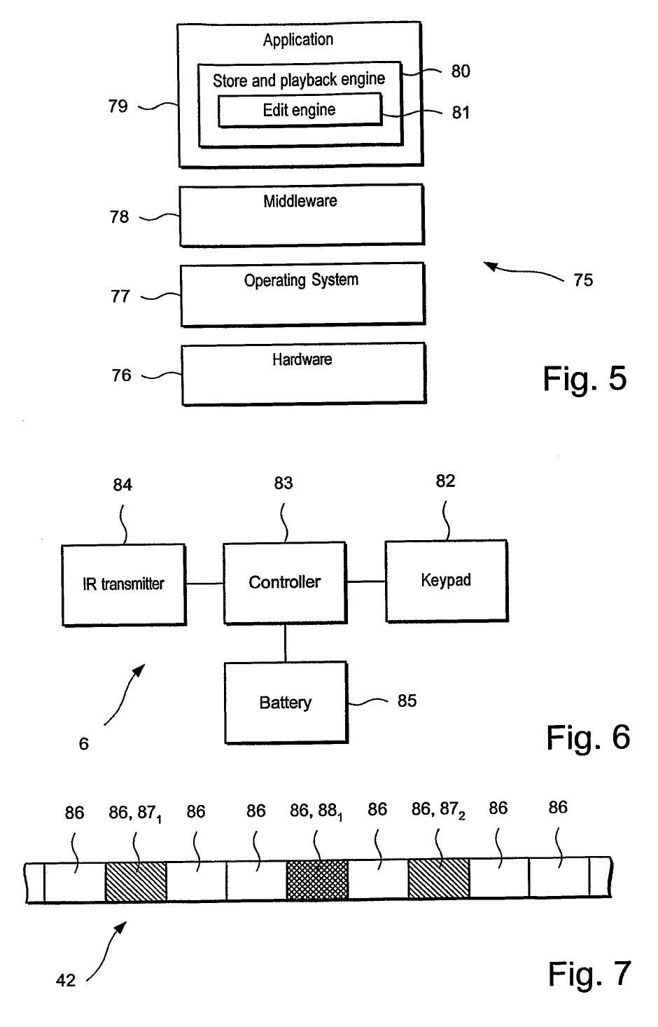

Referring to FIG. 5, a functional layer structure 75 of the mobile terminal 8 is shown. The mobile terminal 8 uses hardware 76, an operating system 77, middleware 78 and applications 79. The operating system 77 and the middleware 78 may be combined. In this example, middleware 78 includes a content storing and playing back engine 80 which includes an editing engine 81. As will be explained in more detail later, the editing engine 81 can be used to transfer, create and manage files.

Remote Control Device 6

Referring to FIG. 5, the remote control device 6 is shown in more detail. The device 6 includes a key pad 82, a controller 83, an infrared interface 84 and a battery 85. It will be appreciated that conventional remote control devices may be used.

Transport Stream

Referring to FIG. 7, the transport stream 42 carried by signal 41 (FIG. 2) is shown in more detail.

The transport stream 42 comprises data packets 86 including data packets 87₁, 87₂ carrying video data and data packets 88₁ carrying service information. In this example, the data packets 86 are in the form of MPEG-2 encapsulated transport stream (TS) packets.

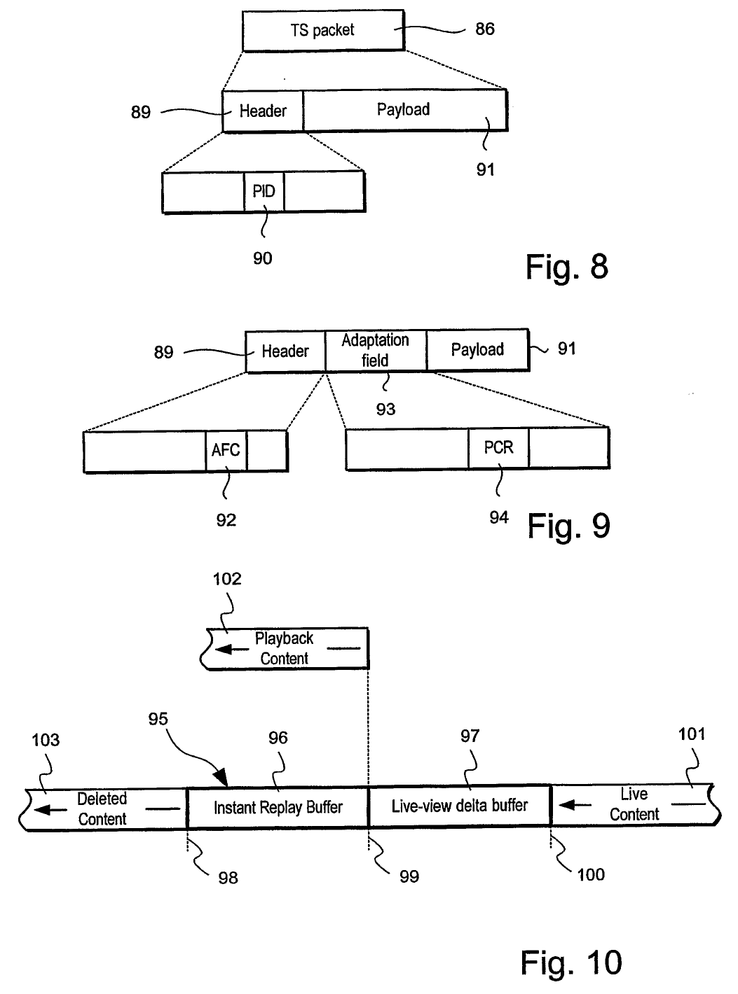

Referring also to FIG. 8, the transport stream 42 is divided into a number of logical channels. The logical channel to which a data packet 86 belongs is defined in a packet header 89 using a packet identifier (PID) 90. The packet identifier can be used to identify contents of a data packet payload 91.

For example, the contents of data packets 87₁, 87₂ may be identified as being video, by specifying a PID value between 0x0030 to 0x1FFE (as hexadecimal number). The contents of a data packet 88₁ may be identified as containing all or part of network information table (NIT) by specifying PID=0x0010.

Referring also to FIG. 9, at least one of the data packets 86 is used for the purpose of timing. For example, a data packet 86 may include an adaptation field control (AFC) field 92 for indicating whether the packet header 89 is followed by an adaptation field 93 and/or payload 91. If the header 89 is followed by an adaptation field 93, the adaptation field may include a program clock reference (PCR) 94.

The PCR 94 and the number of following packets can be used as a basis to refer to a location of a bookmark.

As will be explained in more detail later, if content can be universally identified using a universal identification code, such as PCR 94, then a bookmark file which includes start and stop locations of the bookmarks in terms the universal identification code can become a universally usable file. Thus, the bookmark file can be transferred and used elsewhere to the same effect, namely to identify points, events or moments in the content.

Playback

Referring to FIG. 10, content 21 including content file 95 which is referred to as a playback file 95, is stored in storage 19. The playback file 95 comprises first and second parts 96, 97, a beginning 98, an intermediate point 99 and an end 100.

Live content 101 comprising stream 43₁ (FIG. 2) is added to the second part 97 of the playback file 95 at the end 100 of the file 95. Because of this, the end 100 of the file 95 may be known as the “live position”.

Content 102 is taken from the intermediate point 99 of the file 95 for playback. Because of this, the intermediate point 99 of the file 95 may be known as the “view position”.

The first part 96 of the playback file 95 comprises content preceding the view position 99. The user may or may not have been watched the first part 96 of the playback file 95. The first part 96 of the file 95 may be known as the “instant replay buffer”.

The second part 97 of the playback file 95 comprises content following the view position 99. The user may or may not have been watched the second part 97 of the playback file 95. The second part 97 of the file 95 may be known as the “live-view delta buffer”.

As live content 101 is fed into the end 100 of the playback file 95, the play back file 95 grows. If playback is paused, then the live-view delta buffer 97 grows. If playback occurs, then the view position 99 shifts. Content which was once part of the live-view delta buffer 97 becomes part of the instant replay buffer 96. Thus, the live-view delta buffer 97 remains constant in size, while the instant replay buffer 96 grows. In either case, the size of the play-back file 95, and in particular the instant replay buffer 96, may be kept in check by deleting content 103 from the beginning 98 of the playback file 95.

This type of playback is described in more detail in EP-A-1351500.

A playback file 95 may be created and stored each time a channel is selected. A playback file 95 may be created when the record and playback device 1 is switched on, at the user's request or in response to some other control or trigger. A playback file 95 may include content from more than one channel. Playback file 95 may be deleted when the record and playback device 1 is switched off. The playback file 95 may be cropped, limiting it to a fixed size, so as to prevent the playback file becoming too large. However, the user may override the cropping function.

In this example, the playback file 95 comprises televisual content including video and audio. However, the play back file 95 may comprise two or more files, for example one file for video, another file for audio and optionally further files for data, such as subtitles. The play back file 95 may be encrypted. Thus, content may need to be decrypted before rendering.

Referring to FIG. 11, the remote control device 6 (FIG. 2) has a keypad 82 including keys 82₁, 82₂, 82₃ for controlling playback and keys 82₄, 82₅, 82₆ for controlling editing. A first key 82₁ is for “rewinding” to earlier recorded content. A second key 82₂ is for resuming live playback. A third key 82₃ is for “fast forwarding”.

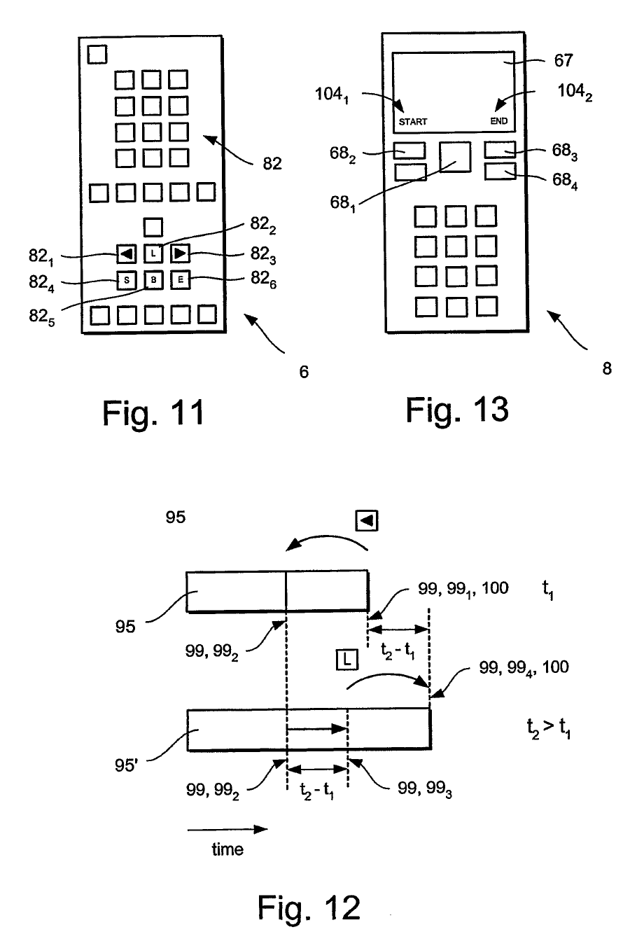

Referring also to FIG. 12, use of the playback control keys 82₁, 82₂, 82₃ is illustrated.

The user presses the first key 82₁ at time t₁. The controller 83 (FIG. 6) sends a command to the record and playback device 1 which causes the view position 99 to shift from a current position 99₁, which in this case happens to be the live position, to an earlier position 99₂. The shift may be a discontinuous jump to earlier content or a continuous, fast rewind to the earlier content through intervening content. If the user continuously presses the first key 82₁, then further shifting of the view position 99 may occur.

Once the view position 99 has shifted, playback may continue. Thus, between time t₁ and t₂, the view position 99 can progress from the earlier position 99₂ to a new position 99₃. In the meantime, the playback file 95′ has grown.

The user presses the second key 82₂ at time t₂. The controller 83 (FIG. 6) sends a command to the record and playback device 1 which causes the view position 99 to shift from the new position 99₃ to the live position 100 at position 99₄.

Referring to FIG. 13, the mobile device 8 (FIG. 2) has a keypad 68 including keys 68₁, 68₂, 68₃ for controlling playback and editing. The mobile device 8 (FIG. 2) may be provided with playback and editing functionality, for example by selecting an option from a menu (not shown). During playback and editing, if a key is 68₁, 68₂, 68₃ is pressed, then the controller 57 (FIG. 4) sends a command to the record and playback device 1 via the first wireless network 9, such as a PAN based on the Bluetooth™ specification.

The first key 68₁ may be a four-direction joystick. Tilting the key 68₁ to the left and right can be used for rewinding and fast-forwarding content respectively. Pressing down on the key 68₁ can be used for returning the current view position 99 to the live position 100. Soft keys 68₂, 68₃ can be used for editing content, such as introducing bookmarks according to the soft key functions 104₁, 104₂ shown in display 67.

Set-Up

The record and playback device 1 can be used simply to playback content. However, as will be explained in more detail later, the record and playback device can also be used to bookmark content, to save specific content, to extract bookmarked content and to transfer bookmarks and/or specific and/or bookmarked content to another device, such as mobile terminal 8.

The record and playback device 1 may be used by more than one user, such as members of a family or flatmates in shared accommodation. Therefore, the record and playback device 1 can also be configured to create personal bookmarks and to save and transfer personally selected content.

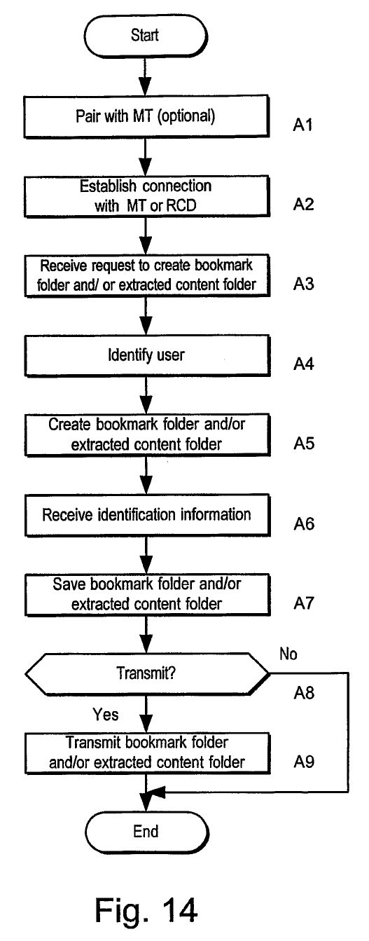

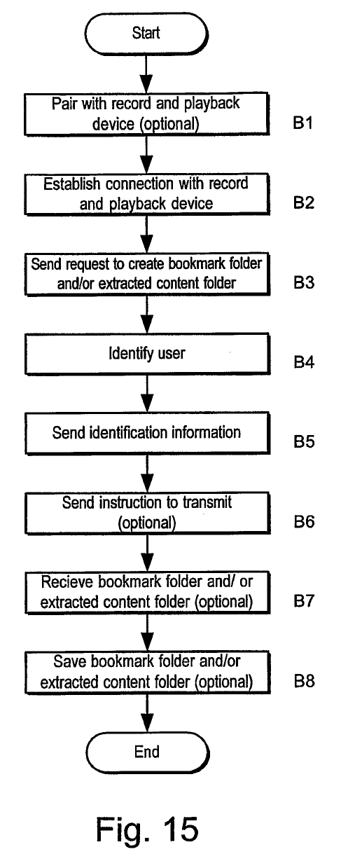

Referring to FIGS. 2, 4, 14 and 15, a method of setting up a record and playback device 1 using a mobile terminal 8 for allowing creation of personal bookmarks and storage and transfer of personally-selected content will now be described. FIG. 14 illustrates operation of the record and playback device 1 and FIG. 15 illustrates operation of a co-operating controller, such as mobile terminal 8.

The record and playback device 1 and the mobile terminal 8 may be paired (steps A1 & B1). For example, the record and playback device 1 and the mobile terminal 8 can be paired in accordance with the Bluetooth™ specification. Pairing may instead occur without Bluetooth connection, for example by using and creating a personal username and/or user id. When pairing, information concerning the paired devices and/or their users, and/or user identification may be stored. Information concerning the paired devices and their users may be later used as a user information when creating bookmark and extraction folders and files.

When the user wishes to set-up the record and playback device 1, the user enters an instruction via keypad 68 for the controller 57 to create a network connection between the mobile terminal 8 and the record and playback device 1 via the PAN 8. This may be achieved by selecting an option from a menu (not shown). The controller 57 establishes a connection (steps A2 & B2). Alternatively, the user may enter an instruction via the user interface 24 for the CPU 17 to create the network connection.

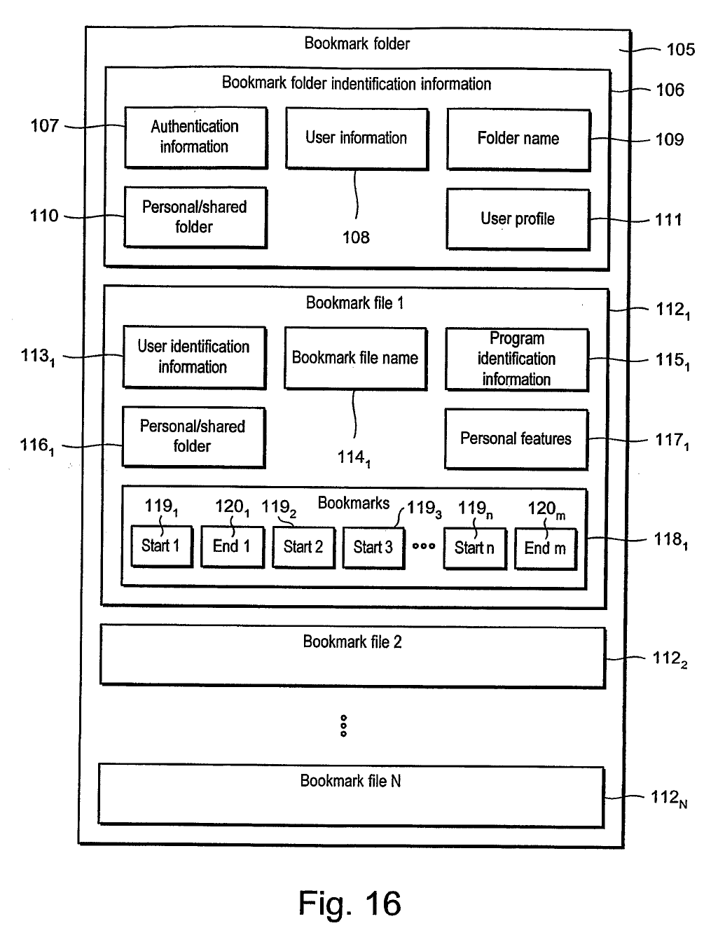

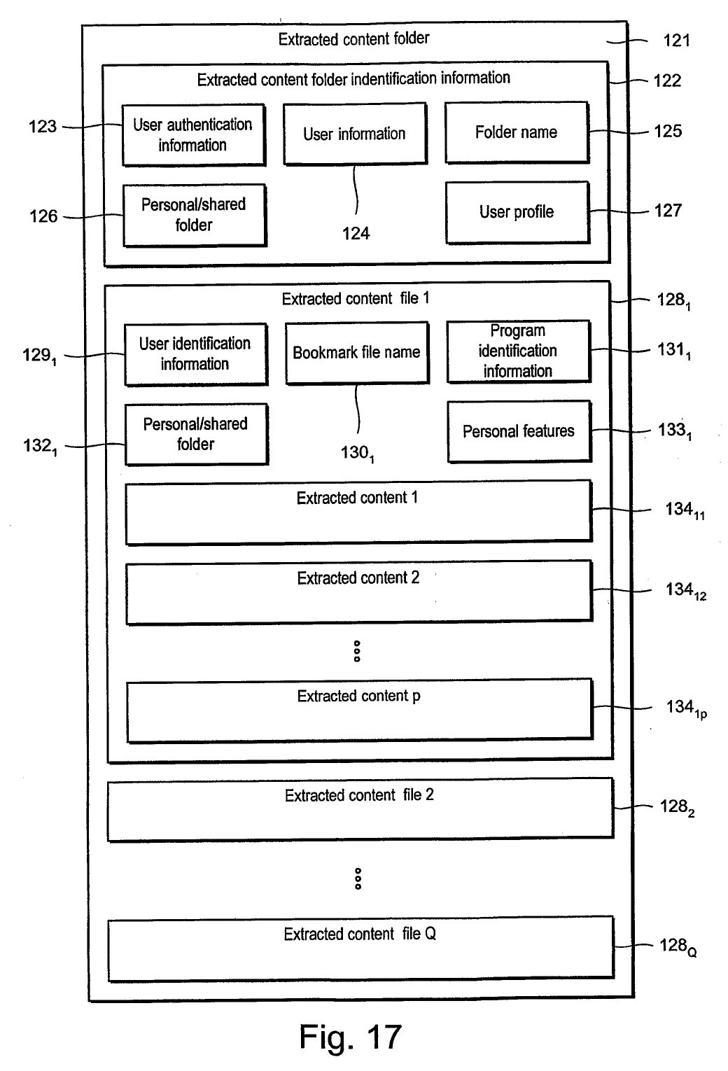

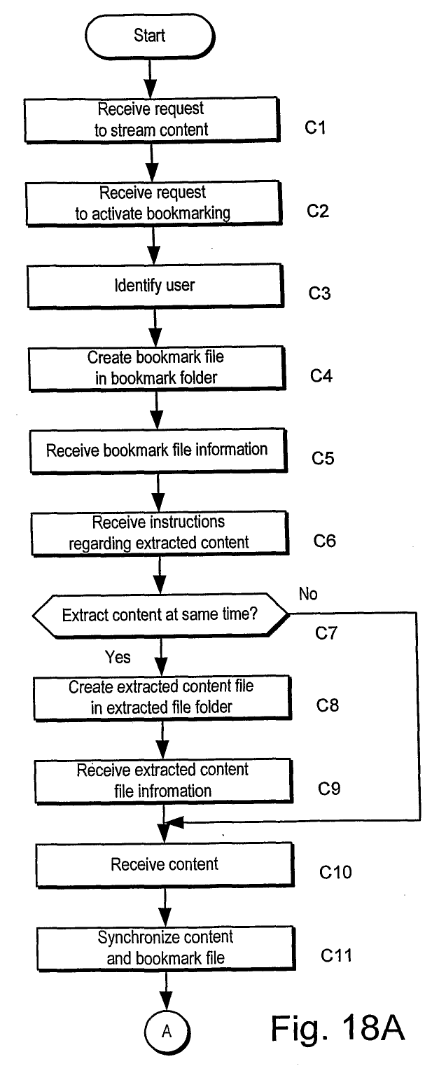

The user enters an instruction via keypad 68 for the controller 57 to instruct CPU 17 to create a bookmark folder 105 (FIG. 16) and/or an extracted content folder 121 (FIG. 17). This may also be achieved by selecting an option from a menu (not shown). The controller 57 transmits a request to create a bookmark folder 105 and/or an extracted content folder 121 (FIG. 17) (step B3) which the CPU 17 receives (step A3).

The CPU 17 and controller 57 carry out user identification (steps A4 & B4). If Bluetooth™ protocols are being used, user identification may be carried out using Bluetooth™ authentication methods, which may or may not require user involvement. User identification when not using Bluetooth authentication, i.e. using a remote control device without Bluetooth technology, may involve asking the user to enter a user name and/or personal identification number (PIN), which are transmitted to the record and playback device 1 and stored in storage 19.

The CPU 17 creates a bookmark folder 105 (FIG. 16) and/or an extracted content folder 121 (FIG. 17) for the user and stores the folders 105, 121 in storage 19 (step A5).

The user enters identification information via keypad 68 and the controller 57 sends the information to the record and playback device 1 (step B5). The CPU 17 receives the information and adds it to the bookmark folder 105 (FIG. 16) and/or an extracted content folder 121 (FIG. 17).

Bookmark Folder

Referring to FIG. 16, an example of a bookmark folder 105 is shown.

The bookmark folder 105 may comprise identification information 106, i.e. metadata, which may comprise user authentication information 107, user information 108, folder name 109, a flag 110 for indicating whether the folder can be shared and/or a user profile 111.

As will be explained in more detail later, a number of bookmark files 112₁, 112₂, 112_{N} may be added to the bookmark folder 105.

Taking the example of the first bookmark file 112₁, a bookmark file may comprise metadata such as user identification information 113₁, a bookmark file name 114₁, program identification 115₁, a flag 116₁ for indicating whether the file can be shared, personal features 117₁ and a set of bookmarks 118₁. The user identification information may be manually created, or copied and/or edited from user identification information that is created when pairing devices.

The set of bookmarks 118₁ may comprise at least one start marker 119₁₁, 119₁₂, 119₁ₙ and at least one end marker 120₁₁, 120₁₂, 120₁ₘ. Start and end markers 119₁₁, 119₁₂, 119₁ₙ, 120₁₁, 120₁₂, 120₁ₘ may be paired, in which case they can define a start and end of a section. However, a marker 119₁₁, 119₁₂, 119₁ₙ, 120₁₁, 120₁₂, 120₁ₘ may be unpaired, in which case it simply marks a point, moment in time, event or the like and is herein after referred to as an “instant point”.

The bookmarks 118₁ are in the form of pointers, for example added to the end of the playback file 95 or stored as a separate file. However, the bookmarks 118₁ may be inserted in a playback file 95. The bookmarks 118₁ employ PCR fields and packet number to identify a given point. However, other time stamping arrangements may be used.

Each user may have a different bookmarking records for different uses. For example, a user may have a different bookmark folder for each type of content, such as sport, films and documentaries, or sub-type of content, such as ice hockey and soccer. This can help provide an extendible, linkable and flexible system for booking.

The record and playback device 1 may automatically collect information about the bookmarks and the bookmarked contents and add them to the bookmark file 112₁, (e.g. to the program identification information file 115). This information may concern the size, duration and/or number of clips. Alternatively, some or all of this information can be added manually by a user. General content metadata information may be fully or partly copied from EPG (electronic program guide), ESG (electronic service guide) or ISG (interactive service guide) information or from the content itself.

Bookmark files can be stored in the same storage, such as the same hard disc or the same DVD, in which content is stored. As will be explained in more detail later, bookmark files can be transferred from a set-top box to a mobile telephone handset via a Bluetooth™ network, and stored in the handset. Bookmark files can be used in the handset or transferred to friends. Use of a universal identification code, such as PCR, helps to identify the same position in both locally-available content and original content. Thus, a rented movie can be bookmarked and the bookmarks shared between friends.

Bookmark files can be stored on personal storage, such as a memory stick, which is provided with connectivity, such as Bluetooth™.

Bookmark files can be downloaded or transferred to a mobile telephone handset using MMS or SMS via a PLMN. Not only can friends exchange or deliver bookmarks, but also a company or any external party may provide a service, such as advertising or reviewing movies or any other digital content, to users. Limiting the number of scenes helps to keep the size of the bookmark file small. Bookmark files can also be downloaded or transferred from a company or any external party to a STB (set-top box) or similar using MMS or SMS via a PLMN, or wireline network, such as the Internet.

Bookmark folders and bookmark files may be presented in EPG (electronic program guide), ESG (electronic service guide), in ISG (interactive service guide) or together with any other form of program information. A specific bookmark file may presented together with related actual digital content, so that user may select the bookmark to watch the actual content or its highlights.

Extracted Content Folder

Referring to FIG. 17, an example of an extracted content folder 121 is shown.

The extracted content folder 121 may comprise user identification information 122, i.e. metadata information, which may comprise user authentication information 123, user information 124, a folder name 125, a flag 126 for indicating whether the folder can be shared and/or a user profile 127.

As will be explained in more detail later, a number of extracted content files 128₁, 128₂, 128_{Q} may be added to the extracted content folder 121.

Taking the example of the first extracted content file 128₁, a extracted content file may comprise metadata information such as user identification information 129₁, a bookmark file name 130₁, program identification 131₁, a flag 132₁ for indicating whether the file can be shared, personal features 133₁ and a set of extracted content 134₁₁, 134₁₂, 134₁ₚ. Each extracted content 134₁₁, 134₁₂, 134₁ₚ may correspond to a respective pair of start and end markers 119₁₁, 119₁₂, 119₁ₙ, 120₁₁, 120₁₂, 120₁ₘ (FIG. 16). Extracted content file information may be fully or partly inherited from a corresponding bookmark file, and manually edited by a user.

Referring again to FIGS. 2, 4, 14 and 15, the CPU 17 saves the bookmark folder 105 (FIG. 16) and/or the extracted content folder 121 (FIG. 17) in storage 19 (step A7).

The user may wish to receive a copy of the bookmark folder 105 (FIG. 16) and/or the extracted content folder 121 (FIG. 17). If so, the user enters an instruction via keypad 68 to transmit a copy of the bookmark folder 105 (FIG. 16) and/or the extracted content folder 121 (FIG. 17). The controller 57 transmits a request to the record and playback device 1 to transmit the bookmark folder 105 and/or the extracted content folder 121 (FIG. 17) (step B6).

If the CPU 17 receives a request to transmit the bookmark folder 105 and/or the extracted content folder 121 (FIG. 17) to the mobile terminal 8 (step A8), then the CPU 17 transmits the bookmark folder 105 and/or the extracted content folder 121 (FIG. 17), for example via the first wireless network 9 (steps A9).

The controller 57 receives the bookmark folder 105 and/or the extracted content folder 121 (FIG. 17) (step B7) and saves the folder or folders 105, 121 in storage 70.

Additionally or alternatively, the remote control unit 6 or the user interface 24 may be used to set up the record and playback device 1. The method is substantially similar to that just described. The method using the remote control unit 6 may differ in that the instructions are sent via the infrared interface 7 (FIG. 1). For example, the remote control device 6 may be easier to use for certain steps than the mobile terminal 8.

Regardless of whether the mobile terminal 8, the remote control unit 6 or the user interface 24 is used, the user may instruct the record and playback device 1 to transmit the bookmark folder 105 and/or the extracted content folder 121 (FIG. 17) to the mobile terminal 8 or to another device 1, via the PAN 9 or PLMN 10, for example as a data message, or in the case of another record and playback device 1′ connected to the wired network 11, via the wired network 11.

Regardless of whether the record and playback device 1 is controlled by the remote control device 6, mobile terminal 8 or keypad of the user interface 24, the record and playback device 1 may display instructions or prompts for the user on the television set 5 or via the display (not shown) of the user interface 24.

Extraction folders and extraction files may be presented in EPG (electronic program guide), ESG (electronic service guide), in ISG (interactive service guide) or together with any other form of program information. A specific bookmark file may presented together with related actual digital content and/or related bookmark file, so that user may select the bookmark to watch the actual content or its highlights.

Bookmarking

The user may bookmark content and then save bookmark and personally selected content to their own or shared folders 105, 121.

The user may bookmark content while content is being received and/or being recorded in the playback file or after content has been recorded. It can help the user to locate given events, moments or scenes. It can also help the user to restart viewing quickly and easily from a given point at a later time.

A set of bookmarks may be assigned a category, such as a film genre or program type. This can help the user to manage his or her bookmarks. Furthermore, a set of bookmarks may be assigned the name of a user. This allows different users to have their own set of bookmarks for the same material. Thus, only a selected set of bookmarks or, if the user interface allows it, several sets of bookmarks can be activated when browsing through material, i.e. content.

If a user defines a bookmark having a start and stop time, the user can piece together highlights of film or program for viewing a later stage. If several such bookmarks are defined then the user can make an “executive summary” of the recording and/or make a shorter version of the film, which may be referred to as a “user's cut” or a “user's choice”.

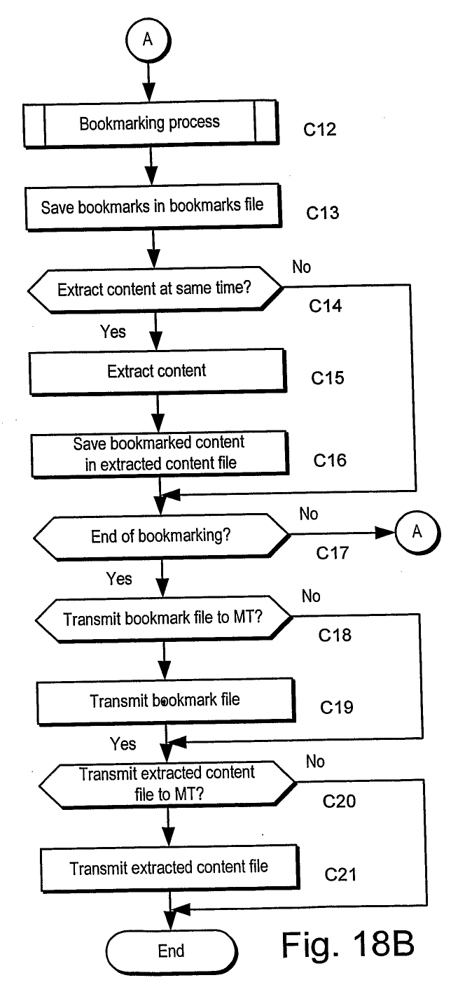

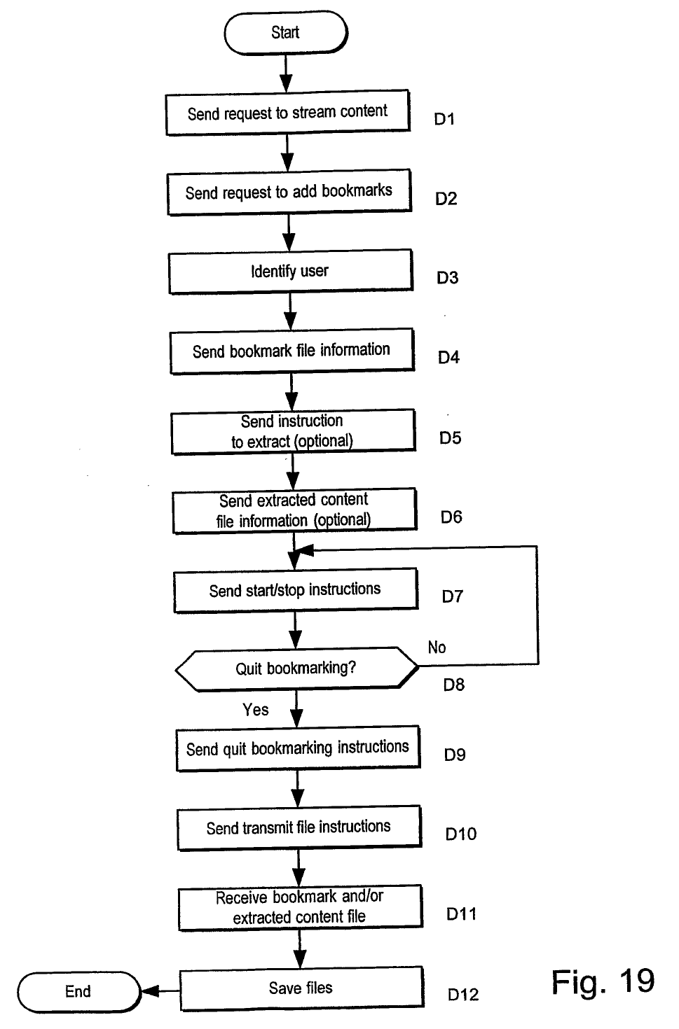

Referring to FIGS. 2, 4, 18 and 19, a method of bookmarking and extracting content will now be described. FIG. 18 illustrates operation of the record and playback device 1 and FIG. 19 illustrates operation of a co-operating controller, such as mobile terminal 8.

If a connection has not already been established, the user may enter an instruction via keypad 68 for the controller 57 to create a network connection between the mobile terminal 8 and the record and playback device 1 via the PAN 8. This may be achieved by selecting an option from a menu (not shown). The controller 57 establishes a connection. Alternatively, the user may enter an instruction via the user interface 24 for the CPU 17 to create the network connection.

The user selects a channel. This may be achieved by the user entering a channel number via keypad 68 or by selecting a channel from a menu (not shown) displayed on the television set 5. Thus, the controller 57 sends a request to stream content for a given channel which is received by record and playback device 1 (steps C1 & D1).

The user may view and playback content as described earlier.

The user selects bookmarking via keypad 68 and the controller 57 sends a request to the record and playback device 1 to activate bookmarking (steps C2 and D2). Alternatively, bookmarking may be automatically activated when content begins to be received or always enabled.

The CPU 17 and controller 57 carry out user identification (steps C3 & D3). If Bluetooth™ protocols are being used, user identification may be carried out using Bluetooth™ authentication methods, which may or may not require user involvement. If not using Bluetooth™, user identification may involve asking the user to enter a user name and/or PIN which are transmitted to the record and playback device 1 and compared with a user name stored in storage 19. If there is a match, then the user is identified.

The CPU 17 creates a bookmark file 112₁ (FIG. 16) in the user's bookmark folder 105 (FIG. 16) stored in storage 19 (step C4).

The user may be prompted to provide bookmark file information. Prompted or unprompted, the user may enter bookmark file information 115₁ (FIG. 16), such as a bookmark file name 114₁ (FIG. 16), program identification 115₁ (FIG. 16), a flag 116₁ (FIG. 16) for indicating whether the file can be shared and personal features 117₁ (FIG. 16) (such as comments, message and/or a description) via keypad 68 and/or by selecting names from a menu, which the controller 57 transmits to the record and playback device 1 (steps C5 & D4).

The user may be prompted as to whether to extract content between a start and end marker or a still picture at an instant point and place the extracted content in a file. Prompted or unprompted, the user may enter an instruction via keypad 68 to extract content. The controller 57 transmits a request to extract content (step C6 & D5).

If the CPU 17 receives an instruction to extract content (step C7), it creates an extracted content file 128₁ (FIG. 17) in the user's extracted content folder 121 (FIG. 17) stored in storage 19 (step C8). However, the CPU 17 may automatically create an extracted content file 128₁ (FIG. 17).

The user may be prompted to provide extracted content file information. Prompted or unprompted, the user may enter extracted content file information such as a bookmark file name 130₁ (FIG. 17), program identification 131₁ (FIG. 16), a flag 132₁ (FIG. 16) for indicating whether the file can be shared and personal features 133₁ (FIG. 16) (such as comments, message and/or a description) via keypad 68 and/or by selecting names from a menu, which the controller 57 transmits to the record and playback device 1 (steps C9 & D6). However, the CPU 17 may automatically copy the extracted content file information from the bookmark file information.

Either before, during or after the steps of creating a bookmark file and an extracted content file, the content 3 is selected and provided as live content 101 (FIG. 10) for storing and playing back (step C10).

The live content 101 (FIG. 10) is synchronised with the bookmark file 112₁ (FIG. 16) (step C11). A PCR (or some other PID) may be stored to used to locate the exact locations of bookmarks in a content file. Reference is made to FIGS. 8 to 10 and the corresponding description above. Program identification information in the bookmark file includes information that identifies the corresponding content file.

The user may begin bookmarking content (step C12 & D7).

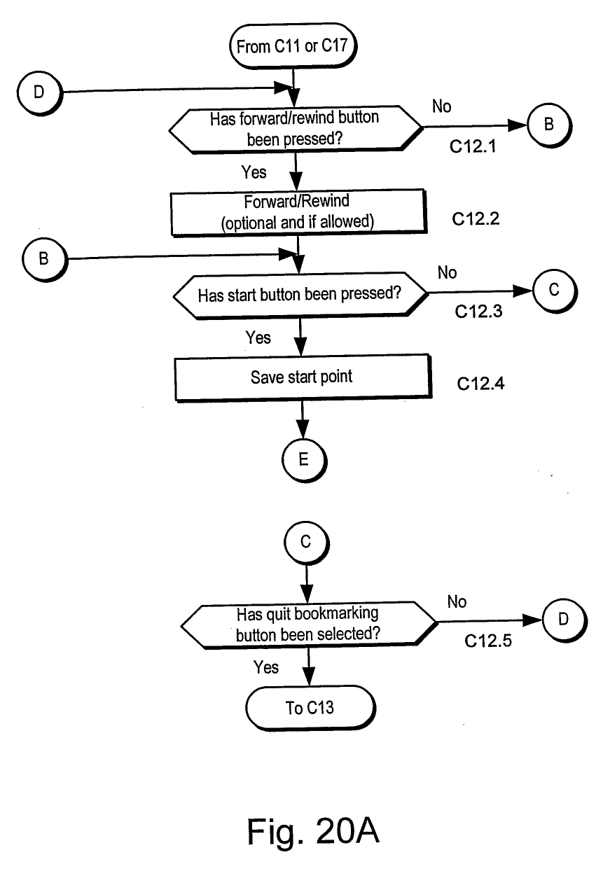

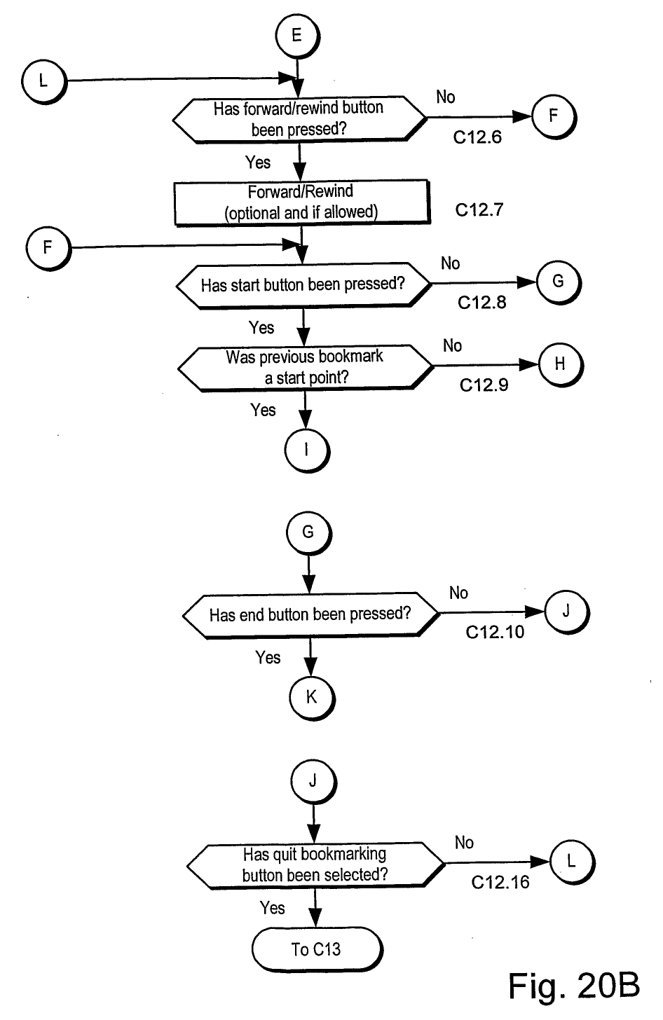

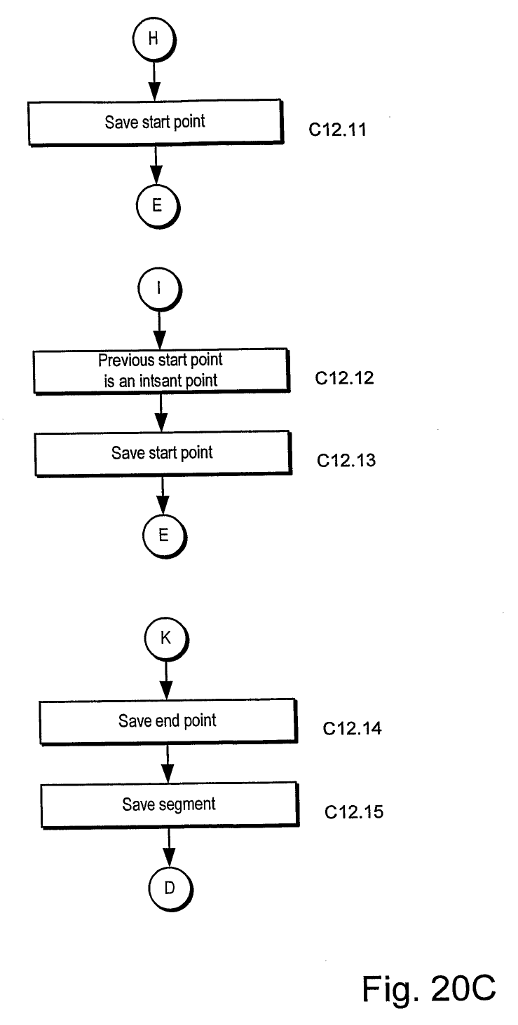

Referring also to FIG. 20, the bookmarking process is shown in more detail:

Briefly stated, the bookmarking process includes two sub-processes. A first sub-process is for when the record and playback device 1 is in a first state, for example when no bookmarks have been placed or when the last bookmark to have been placed is an end bookmark (steps C12.1 to C12.5). A second sub-process is for when the record and playback device 1 is in a second state, for example when the last bookmark to have been placed is a start bookmark (steps C12.6 to C12.16).

In the first state, the user may forward or rewind content before bookmarking. Therefore, a check is made whether the user has pressed forward or rewind (step C12.1). If so, content is forwarded or rewound accordingly (step C12.2). If not, a check is made whether the user wishes to place a start point bookmark (step C12.3)

For example, if the key 68₁ is tilted to the right or left, then the controller 57 sends a forward or rewind command to the record and playback device 1. If the CPU 17 is notified by the controller 57 that the key 68₁ has been tilted to the right or left, it moves the current position 99 (FIG. 10) forwards or backwards accordingly. Additionally or alternatively, the current position 99 may progress as the user watches the content.

It will be appreciated that the user need not forward or rewind content. It will also be appreciated that the user may not be allowed to forward or rewind content, for example if the view position is at the end 98 or start 100 of the playback file 95.

Whether or not the user forwards or rewinds content, a check is made whether the user wishes to place a start point bookmark (step C12.3 & D7). If so, a start point bookmark is placed (step C12.4). If not, a check is made whether the user wishes to quit bookmarking (step C12.5).

For example, if the start key 68₂ is pressed, then the controller 57 sends start point command to the record and playback device 1. If the CPU 17 is notified by the controller 57 that the user has pressed the start button 68₂, it stores a start point 119₁ in bookmarks 118₁. Otherwise, it continues to monitor whether the key 68₁ has been tilted or if the start key 68₂ has been pressed.

If the user has not pressed the start button, a check is made whether the user wishes to quit bookmarking (step C12.5).

For example, if a cancel key 68₄ (FIG. 13) is pressed, then the controller 57 sends a quit bookmarking instruction to the record and playback device 1. If the CPU 17 is notified by the controller 57 that the cancel key 68₄ (FIG. 13) has been pressed, then it quits bookmarking. An instruction to quit bookmarking may be implied, for example if the user switches channel.

If the user has not quit bookmarking, then the record and playback device 1 remains in the first state and continues to monitor whether the forward/rewind buttons have been pressed, whether the start point bookmark has been placed or whether the user wishes to quit bookmarking (step C12.1 to C12.5).

It will be appreciated that CPU 17 may monitor and act upon other user instructions, such as volume control.

If a start point bookmark has been placed, then the record and playback device 1 switches to a second state.

In the second state, the user may forward or rewind content before further bookmarking. Therefore, a check is made whether the user has pressed forward or rewind (step C12.6). If so, content is forwarded or rewound accordingly (step C12.7). If not, a check is made whether the user wishes to place a start point bookmark (step C12.8).

For example, if the key 68₁ is tilted to the right or left, then the controller 57 sends a forward or rewind command to the record and playback device 1. If the CPU 17 is notified by the controller 57 that the key 68₁ has been tilted to the right or left, it moves the current position 99 (FIG. 10) forwards or backwards accordingly. Additionally or alternatively, the current position 99 may progress as the user watches the content.

It will be appreciated that the user need not forward or rewind content. It will also be appreciated that the user may not be allowed to forward or rewind content, for example if the view position is at the end 98 or start 100 of the playback file 95.

Whether or not the user forwards or rewinds content, a check is made whether the user wishes to place a start point bookmark (step C12.8 & D7). If so, a check is made whether the previous bookmark was a start point bookmark is placed (step C12.9). If not, a check is made whether the user wishes to place an end point bookmark (step C12.10).

For example, if the start key 68₂ is pressed, then the controller 57 sends start point command to the record and playback device 1. If the CPU 17 is notified by the controller 57 that the user has pressed the start button 68₂, it checks whether the previous bookmark was a start point 119₁ or an end point 120₁.

If the previous bookmark was not a start point 119₁, in other words it was an end point 120₁, then a start point bookmark is placed 119₂ (step C12.11).

For example, the CPU 17 stores another start point 119₂ in bookmarks 118₁ and continues to monitor for notifications from the controller 57.

If the previous bookmark was a start point 119₂ and there is no end point paired with it, then the start point 119₂ is an instant point (step C12.12). A start point bookmark 119₃ is placed (step C12.13) and a check is made whether the user wishes to fast-forward or rewind continues (step C12.6).

For example, the CPU 17 checks whether an end point follows start point 119₂. If it does not find an end point, then it stores another start point 119₃ in bookmarks 118₁ and continues to monitor for notification by the controller 57. Optionally, the CPU 17 may place a flag or identifier for indicating that start point 119₂ is unpaired.

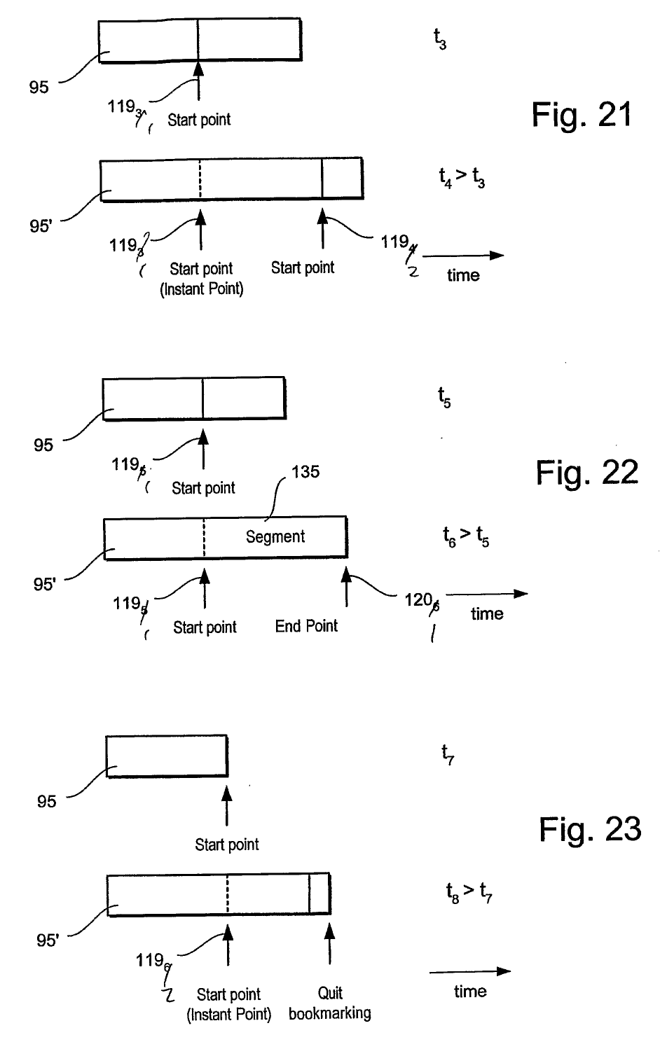

An example of two successive start point bookmarks 119₁, 119₂ in a playback file 95 is shown in FIG. 21. The first start point bookmark 119₁ is placed at time t₃ and a second start point bookmarks 119₂ is placed at time t₄. Placing the second start point bookmarks 119₂ after the first start point bookmark 119₁ without the first start point bookmark 119₁ being paired with an end point bookmark results in the first start point bookmark 119₁ becoming an instant point.

If the user does wish to place a start point (step C12.8), then a check is made whether the user wishes to place an end point bookmark (step C12.10). If so, an end point bookmark is placed (step C12.14), thus defining a segment or section (C12.15). The record and playback device 1 returns to the first state. If not, a check is made whether the user wishes to quit bookmarking (step C12.16).

For example, if the end key 68₃ is pressed, then the controller 57 sends end point command to the record and playback device 1. If the CPU 17 is notified by the controller 57 that the user has pressed the end button 68₃, it places an end point bookmark 120₁ in bookmarks 118₁ and pairs the end point 120₁ with start point 119₁.

An example of a pair of start and end point bookmarks 119₁, 120₁ in a playback file 95 is shown in FIG. 22. The start point bookmark 119₁ is placed at time t₅ and end point bookmarks 120₁ is placed at time t₆. Placing the end point bookmark 120₁ after the start point bookmark 119₁ results in the start and end point bookmarks 119₁, 120₁ being paired and a section 135 being defined. Content within section 135 can be extracted.

If the user does wish to place a start point or an end point, then a check is made whether he or she wishes to quit bookmarking (steps C12.16).

For example, if a cancel key 68₄ (FIG. 13) is pressed, then the controller 57 sends a quit bookmarking instruction to the record and playback device 1. If the CPU 17 is notified by the controller 57 that the cancel key 68₄ (FIG. 13) has been pressed, then it quits bookmarking. An instruction to quit bookmarking may be implied, for example if the user switches channel.

If the user has not quit bookmarking, then the record and playback device 1 remains in the second state and continues to monitor whether the forward/rewind buttons have been pressed, whether another start point bookmark or an end point bookmark has been placed or whether the user wishes to quit bookmarking (step C12.6 to C12.16).

Referring to FIG. 23, if the user quits bookmarking at step C12.16, then any unpaired start point bookmark 119₂ becomes an instant point.

Referring again to FIGS. 18 and 19, when the user has finished bookmarking (steps D8 & D9 and step C12.5 or C12.16), if the CPU 17 has not already done so, it saves the bookmarks in the bookmark file 118₁ (step C13).

If the CPU 17 has received an instruction to extract content, then it extracts content corresponding to sections 135 (FIG. 22) and/or instant points 119₁, 119₂ (step C14 & C15) and saves extracted content 134₁ (FIG. 17) (step C16).

The user may instruct the record and playback device 1 to transmit at least bookmark and/or extracted content files 112₁, 112₂, 112_{N}, 128₁, 128₂, 128_{N} to the mobile terminal 8 (FIG. 1) or other device (step D10). However, the user may have provided instructions earlier, for example when providing bookmark or extracted content file information.

If the CPU 17 has received an instruction to transmit the bookmark files 112₁ and/or any other bookmark files 112₂, 112_{N} to the mobile terminal 8 (FIG. 1) or other device, then the CPU 17 transmit the bookmark files 112₁, 112₂, 112_{Q} accordingly (steps C18 & C19). However, the CPU 17 may automatically attempt to transmit the bookmark files 112₁ immediately on quitting bookmarking.

If the CPU 17 has received an instruction to transmit the extracted content file 128₁ and/or any other extracted content files 128₂, 128_{Q} to the mobile terminal 8 (FIG. 1) or other device, then the CPU 17 transmit the extracted content files 128₁, 128₂, 128_{Q} accordingly (steps C20 & C21). However, the CPU 17 may automatically attempt to transmit the extracted content files 128₁ immediately on quitting bookmarking.

Upon receipt of files 112₁, 112₂, 112_{N}, 128₁, 128₂, 128_{N} the mobile terminal 8 may save the files 112₁, 112₂, 112_{N}, 128₁, 128₂, 128_{N} in storage 70 (FIG. 4).

The user may employ the remote control device 6 instead of mobile terminal 8 for transmitting some or all of the instructions shown in FIG. 19. For example, the user may use the remote control device 6 to select a channel and to lay down start and end points, while using the mobile terminal 8 to set up bookmark and extracted content files.

More than one user may bookmark while watching the same content. Therefore, the record and playback device 1 may perform some or all of the steps shown in FIGS. 18 and 20 for each user. Thus, plural mobile terminals and/or plural remote control devices may be used.

Bookmarking an Ice Hockey Game

An example of a situation when a user might want to use bookmarking is watching a game, such as a game of ice hockey.

The ice hockey game is received and played back using storage 19 (FIG. 1). While watching the game, the user wants to store the highlights of the game in his or her personal bookmark folder 105 (FIG. 16) for future viewing. For example, the user may want to keep an archive of highlights from a team's games in a season. Each game may be stored as a different bookmark file (112₁, 112₂, 112_{N}).

If the user notices an incident, he or she can keep a record of the incident using bookmarks. For example, a player is fouled and the opposing team is given a two-minute penalty. The user can record the incident in a number of ways:

Firstly, the user can rewind content, replay the foul and place bookmarks while watching. The user can insert a start point bookmark just before the foul and an end point bookmark when the two-minute penalty expires. The bookmarks specify a segment of content. As explained earlier, the user may control bookmarking using the remote control device or their mobile phone.

Secondly, the user can wait for a replay, i.e. a replay defined by the production team or content provider. The user can insert a start point bookmark as the replay starts and an end point bookmark as the replay ends without needing to rewind and fast-forward. One drawback of this approach is that not all incidents are replayed. On the other hand, replays can include different views of the same incident.

Of course, the user can combine both approaches or can insert bookmarks “on-the-fly”.

During the course of a game, the user can insert several bookmarks which define a plurality of plural segments, each one relating to different incidents. After the game, the can user stores the bookmarks in separate files in his or her personal bookmark folder in storage 19.

If user does not want to store the whole game, he or she can extract the highlights of the game by running the specific bookmark file with the content file and saving the extracted content in an extracted content file in an extracted content folder in storage 19.

Extracting selected content from original content using bookmarks reduces the content to be stored, transmitted and viewed. This is beneficial when transmitting content wirelessly, since it saves storage capacity in storage devices by making it possible to delete the original content. It can also be time saving by offering summaries or highlight of the original content to be viewed.

As will be described later, the user can edit the bookmark file to watch and/or extract different versions of highlights of the game.

As will also be explained in more detail later, the user can transmit the bookmark file with a content file or the extracted content file to his mobile terminal. Next day, for example, he or she can show the highlights of the game to his colleagues at work by playing back the extracted file or bookmark file together with the content file.

As will also be explained in more detail later, the user can transmit the extracted content file to a friend to allow the friend to watch the game's highlights. Alternatively, the user can transmit only the bookmark file. In turn, the friend can transmit the bookmark file to their own record and playback device 1′ (FIG. 30) and run the bookmark file with their own recorded content file. The friend can watch, extract content, edit and save the highlights as they please using their own record and playback device 1′.

Extracting selected content from original content using bookmarks reduces the content to be stored, transmitted and viewed. This is beneficial when transmitting content wirelessly, since it saves storage capacity in storage devices by making it possible to delete the original content. This may also be time saving by offering summaries or highlight of the original content to be viewed.

Editing

The user may edit bookmark content and save bookmarks and personally-selected content to their own or shared folders 105, 121.

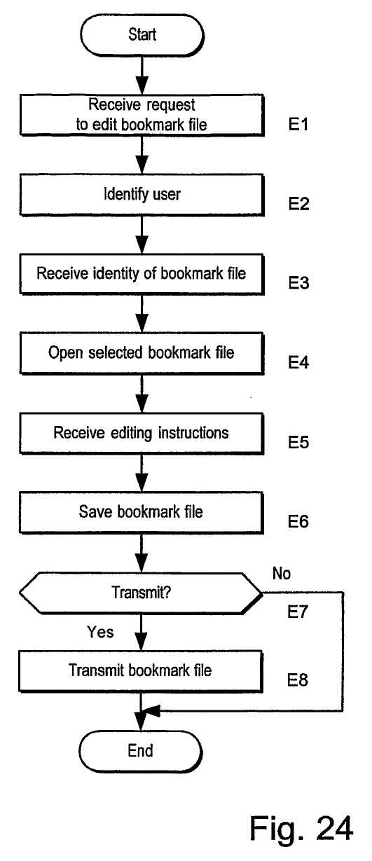

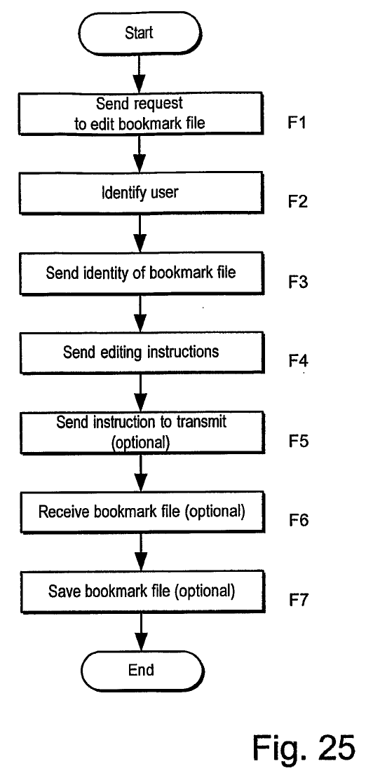

Referring to FIGS. 2, 4, 24 and 25, a method of editing bookmarks will now be described. FIG. 24 illustrates operation of the record and playback device 1 and FIG. 25 illustrates operation of a co-operating controller, such as mobile terminal 8.

If a connection has not already been established, the user may enter an instruction via keypad 68 for the controller 57 to create a network connection between the mobile terminal 8 and the record and playback device 1 via the PAN 8. This may be achieved by selecting an option from a menu (not shown). The controller 57 establishes a connection. Alternatively, the user may enter an instruction via the user interface 24 for the CPU 17 to create the network connection.

The user selects editing via keypad 68 and the controller 57 sends a request to the record and playback device 1 to begin editing (steps E1 and F1).

The CPU 17 and controller 57 carry out user identification (steps E2 & F2). If Bluetooth™ protocols are being used, user identification may be carried out using Bluetooth™ authentication methods, which may or may not require user involvement. If not using Bluetooth™ authentication, user identification may involve asking the user to enter a user name and/or PIN which are transmitted to the record and playback device 1 and compared with a user name stored in storage 19. If there is a match, then the user is identified.

The user selects a bookmark file, for example the first bookmark file 112₁, via keypad 68 and the controller 57 sends a request to the record and playback device 1 to open the bookmark file 112₁ (steps E3 & F3). This may be achieved by selecting an option from a menu (not shown) displayed, for example on the mobile terminal's display 67 or the television set 5.

The CPU 17 opens the selected bookmark file 112₁ (step E4). The CPU 17 may display the contents of the bookmark file 112₁, for example using the television set 5. The bookmark file name 114₁ may be displayed as text. Bookmarks 119₁, 120₁, 119₂, 119₃, 119₂, 120ₘ may be displayed as thumbnail pictures. Bookmarks 119₁, 120₁, 119₂, 119₃, 119₂, 120₁ may be shown as positions in the playback file 95 in a similar format to that shown in FIGS. 21 to 23. Bookmarks 119₁, 120₁, 119₂, 119₃, 119₂, 120ₘ may be listed, for example according to name or timing.

The user may edit the bookmark file 112₁ by entering instructions and/or text via keypad 68. The controller 57 sends the instructions and/or text to the record and playback device 1 and the CPU 17 edits the bookmark file 112₁ accordingly (steps E4 & F4).

For example, editing the bookmark file 112₁ may include adding or changing the bookmark file name 114₁. Editing the bookmark file 112₁ may include adding, shifting, deleting or changing the type of bookmarks 119₁, 120₁, 119₂, 119₃, 119₂, 120₁. Editing the bookmark file 112₁ may include adding, changing or deleting icons or pictures for bookmarks 119₁, 120₁, 119₂, 119₃, 119₂, 120ₘ. Editing the bookmark file 112₁ may include adding, changing or deleting personal features 117₁. Editing the bookmark file 112₁ may include copying, renaming or deleting the bookmark file 112₁.

Once editing has been completed, the CPU 17 saves the selected bookmark file 112₁ to storage 16 (step E6).

The user may request for the bookmark file 112₁ or a copy thereof to be transmitted to another device, such as mobile terminal 8. The user enters an instruction via keypad 68 and the controller 57 sends an instruction to the record and playback device 1 to transmit the bookmark file 112₁ (steps F5).

If the CPU 17 receives an instruction to transmit the bookmark file 112₁, then it transmits the bookmark file 112₁ (steps E7 & E8).

The controller 57 receives the bookmark file 112₁ and saves the file in storage 19 (steps F6 & F7).

Thus, the user can edit bookmarks and organise a collection of bookmarks.

He or she may assign parameters to the bookmark collection, such as name, owner and description.

He or she may provide additional information or content. For example, they may add a sound recording of screaming and shouting occurring in a living room during ice-hockey match. He or she may add text notes, voice-overs or other content, for instance in a picture-in-picture window. This can be used for home-video applications or professional editing application. He or she may add links to other bookmarks in previously recorded content, such as goals in previous matches.

He or she can copy the bookmark collection, rename the copy and make changes by adding, moving and removing bookmarks to/from the copy to make it more suitable for some other purposes.

The user may allow another user to access the content or the bookmarks. Access may be granted on different levels, such Although the other user may not authorised to edit the user's bookmarks, he or she may be permitted to access previously recorded bookmarks, which could be made visible (while watching the contents) to the user somehow

As mentioned earlier, the user can make an “executive summary” of the recorded material by adding bookmarks throughout the recorded material.

The user can process bookmarks and extracted content to provide an improved executive summary. For example, he or she can introduce fading out and fading in of sound between bookmark sections and fading out. Additionally or alternatively, they can introduce fading out and fading in of a picture between bookmark sections using a background or special effects. He or she can search for convenient cut-off points close to the selected bookmark and mark them.

Fade-in and fade-out effects can be achieved by editing the playback file and storing the executive summary as an additional file or as a replacement for the playback file. Fade-in and fade-out effects can also be achieved by making a bookmark file, which may be an additional file or an extension of an original bookmark file, containing the fading effects and replacing the original audio and/or video at run-time.

Extracting Content

As mentioned earlier, the user may wish to render content using another device, such as mobile terminal 8. To minimise unnecessary data transfer, the user may extract relevant content from the playback file and transmit only the extracted content.

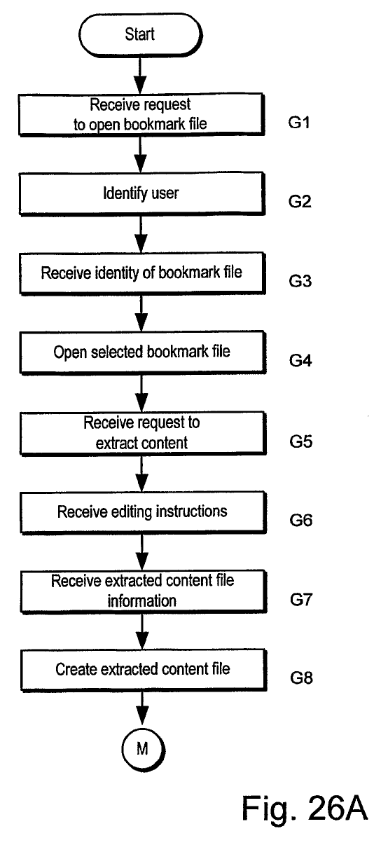

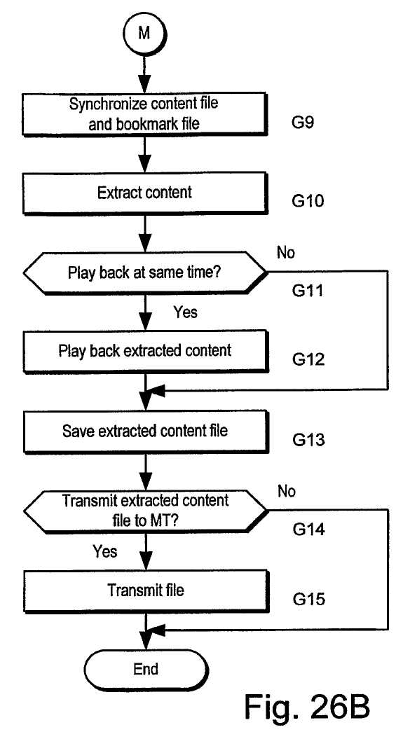

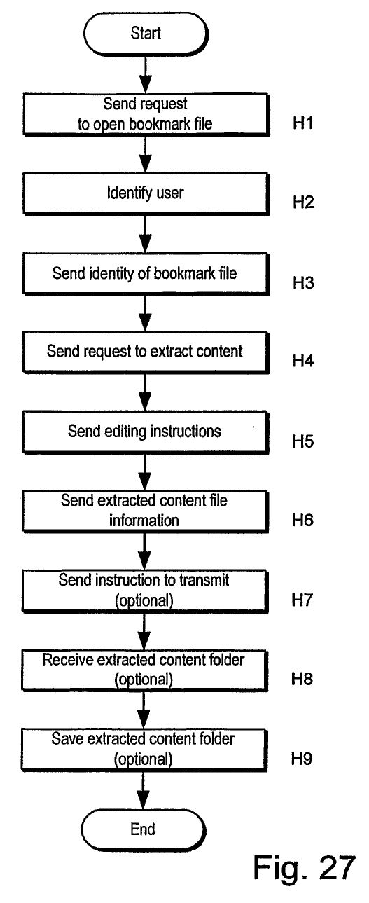

Referring to FIGS. 2, 4, 26 and 27, a method of extracting content will now be described. FIG. 26 illustrates operation of the record and playback device 1 and FIG. 27 illustrates operation of a co-operating controller, such as mobile terminal 8.

If a connection has not already been established, the user may enter an instruction via keypad 68 for the controller 57 to create a network connection between the mobile terminal 8 and the record and playback device 1 via the PAN 8. This may be achieved by selecting an option from a menu (not shown). The controller 57 establishes a connection. Alternatively, the user may enter an instruction via the user interface 24 for the CPU 17 to create the network connection.

The user selects an option to open a bookmark file via keypad 68 and the controller 57 sends a request to the record and playback device 1 to open a bookmark file (steps G1 and H1).

The CPU 17 and controller 57 carry out user identification (steps G2 & H2). If Bluetooth™ protocols are being used, user identification may be carried out using Bluetooth™ authentication methods, which may or may not require user involvement. User identification may involve asking the user to enter a user name and/or PIN which are transmitted to the record and playback device 1 and compared with a user name stored in storage 19. If there is a match, then the user is identified.

The user selects a bookmark file, for example the first bookmark file 112₁, via keypad 68 and the controller 57 sends a request to the record and playback device 1 to open the bookmark file 112₁ (steps G3 & H3). This may be achieved by selecting an option from a menu (not shown) displayed, for example on the mobile terminal's display 67 or the television set 5.

The CPU 17 opens the selected bookmark file 112₁ (step G4).

The user selects an option to extract content via keypad 68 and the controller 57 sends a request to the record and playback device 1 (steps G5 and H4).

The CPU 17 may display a number of extraction options to the user, for example via the television set 5. The options may include extraction of content from all segments sequentially, extraction of content from selected segments, extraction of content from one selected bookmark, extraction of content from all instant points (i.e. extraction of stills pictures) and/or extraction of content from selected instant points.

The user selects an extraction via keypad 68 and the controller 57 sends a request to the record and playback device 1 (steps G6 and H5).

The user enters identification information, such as name 130₁, via keypad 68 and the controller 57 sends the information to the record and playback device 1 (steps G6). The CPU 17 receives the information, creates an extracted content file, for example extracted content file 128₁, and adds the information to the extracted content file 128₁ (FIG. 17) (steps G7 & G8).

The playback file 95 (FIG. 10) is synchronised with the bookmark file 112₁ (FIG. 16) (step G9) and content is extracted to the extracted content file 128₁ (FIG. 17) (step G10).

The extracted content may be played back while extraction is taking place. The user may instruct the store and playback device 1 to playback the extracted content.

The CPU 17 extracts content from the playback file 95 (step G10), optionally forwards the content for rendering by the television set 5 (steps G11 & G12) and saves the content to the extracted content file 128₁ in storage 19 (step G13).

The user may request for the extracted content file 128₁ or a copy thereof to be transmitted to another device, such as mobile terminal 8. The user enters an instruction via keypad 68 and the controller 57 sends an instruction to the record and playback device 1 to transmit the extracted content file 128₁ (steps H7).

If the CPU 17 receives an instruction to transmit the extracted content file 128₁, then it transmits the extracted content file 128₁ (steps G14 & G15).

The controller 57 receives the extracted content file 128₁ and saves the file in storage 19 (steps H8 & H9).

Transmitting Files to Another Device

As mentioned earlier, the user may wish transmit a bookmark file, an extracted content file and a content file to another device, such as mobile terminal 8.

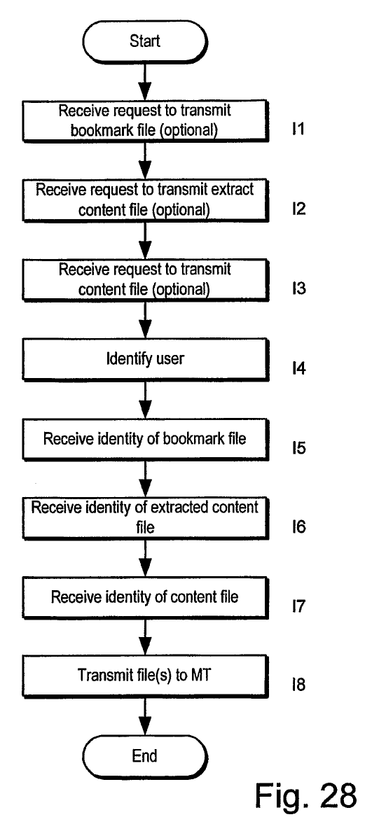

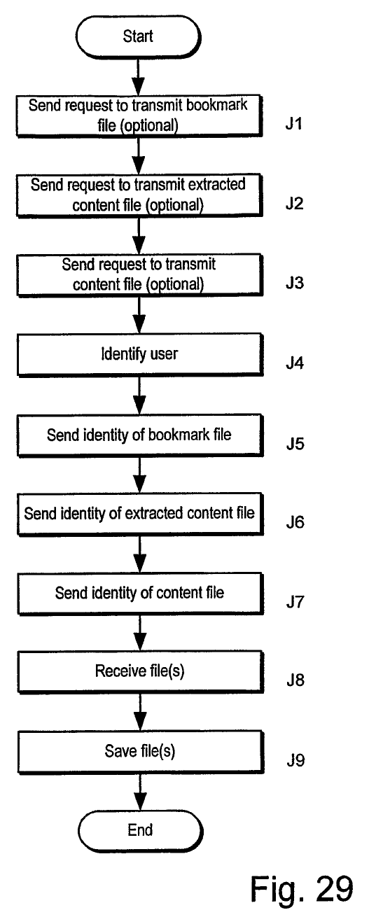

Referring to FIGS. 2, 4, 28 and 29, a method of transmitting files content will now be described. FIG. 28 illustrates operation of the record and playback device 1 and FIG. 29 illustrates operation of a co-operating controller, such as mobile terminal 8.

If a connection has not already been established, the user may enter an instruction via keypad 68 for the controller 57 to create a network connection between the mobile terminal 8 and the record and playback device 1 via the PAN 8. This may be achieved by selecting an option from a menu (not shown). The controller 57 establishes a connection. Alternatively, the user may enter an instruction via the user interface 24 for the CPU 17 to create the network connection.

The user selects an option via keypad 68 and the controller 57 sends a request to the record and playback device 1 to transmit a bookmark file, an extract content file or a playback file (steps I1-I3 & J1-J3).

The CPU 17 and controller 57 carry out user identification (steps I4 & J4). If Bluetooth™ protocols are being used, user identification may be carried out using Bluetooth™ authentication methods, which may or may not require user involvement. User identification may involve asking the user to enter a user name and/or PIN which are transmitted to the record and playback device 1 and compared with a user name stored in storage 19. If there is a match, then the user is identified.

The user selects a bookmark file, for example the first bookmark file 112₁, an extracted content file, such as extracted content file 128₁ and/or playback file, such as playback file 95, via keypad 68 and the controller 57 sends a request to the record and playback device 1 to transmit the file or files 112₁, 128₁, 95 (steps I5-I7 & J5-J7). This may be achieved by selecting an option from a menu (not shown) displayed, for example on the mobile terminal's display 67 or the television set 5.

The CPU 17 transmits the file or files 112₁, 128₁, 95 (steps 18).

The controller 57 receives the file or files 112₁, 128₁, 95 and the file or files 112₁, 128₁, 95 in storage 19 (steps J8 & J9).

Playing Back an Extracted Content File in Another Device

Referring to FIG. 30, the record and playback device 1 can transmit content and files to another record and playback device 1′ via one or more mobile terminals 8, 8′. The other record and playback device 1′ is substantially similar to the record and playback device 1′ shown in FIG. 2. For example, the record and playback device 1′ includes a CPU 17′ and storage 19′.

Alternatively the record and playback device 1 may transmit content and files directly to the another record and playback device 1′ via PAN or PLMN.

As described earlier, the record and playback device 1 can transfer a file or files 112₁, 128₁, 95 to the mobile terminal 8. In turn, these can be transferred to another mobile terminal 8′ is the same way.

Referring also to FIG. 31, the mobile terminal 8, 8′ may store a content folder 136, a bookmark folder 137 and an extracted content folder 138 which include a copy of the playback file 95, a copy of the bookmark file 112₁ and a copy of extracted content file 128₁ respectively. The user may edit the files 112₁, 128₁, 95 in a similar way to that described earlier. The user may transfer other files (not shown) from the record and playback device 1 or other devices and store them in folders 136, 137, 138. Thus, it will be appreciated that the bookmark and extracted content folders 137, 138 stored in mobile terminal 8 may differ from the bookmark and extracted content folder 105, 121 stored in the record and playback device 1.

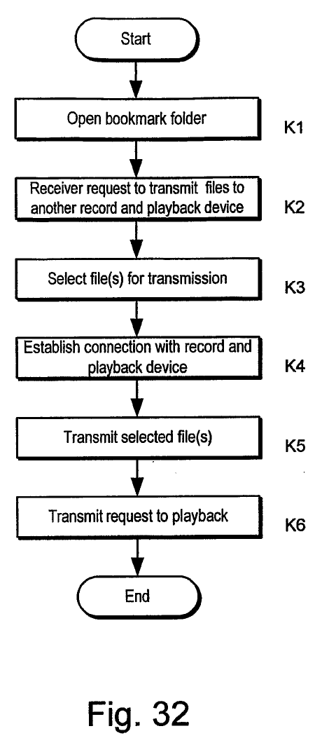

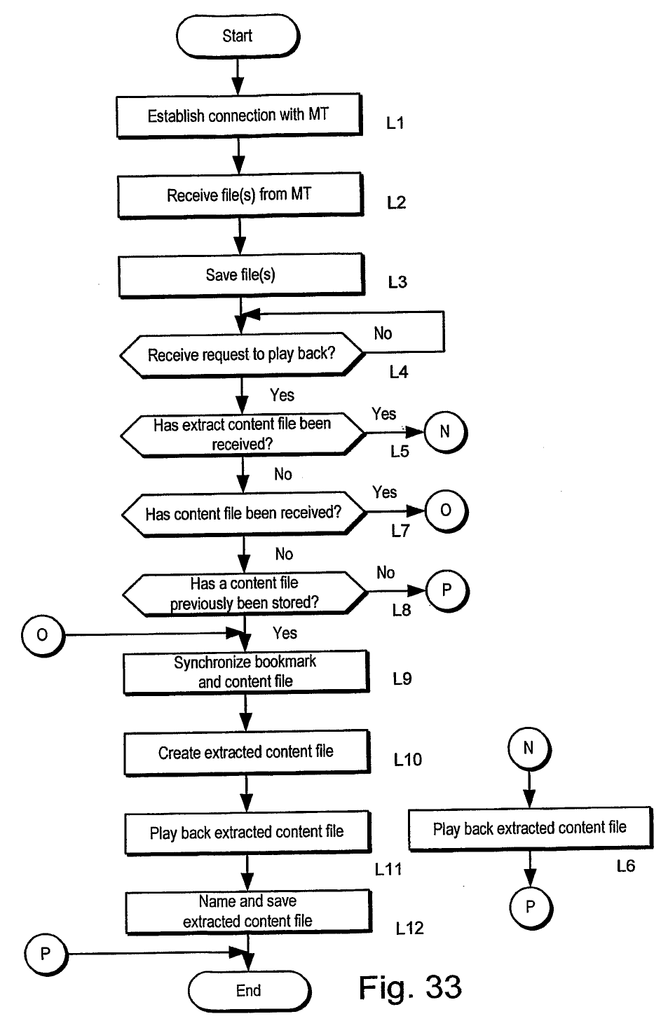

Referring to FIGS. 2, 4, 31, 32 and 33, a method of transmitting files and/or content will now be described. FIG. 32 illustrates operation of the mobile terminal 8 and FIG. 33 illustrates operation of other record and playback device 1′.

The user selects the bookmark folder 137 stored in the mobile terminal 8. The controller 57 opens the selected bookmark folder (step K1) and presents the user with a set of options. The user selects an option to transmit files to another record and playback device 1′. The controller 57 receives the instruction (step K2) and presents the user with a list of files. The user can select which files he or she wishes to transmit to record and playback device 1′ (step K3). In this example, the user selects to transmit the bookmark file 1121.

The controller 57 automatically establishes a connection between the mobile terminal 8 and the record and playback device 1′ via the PAN 8′ (steps K4 & L1). However, the controller 57 may wait until instructed to do so by the user.

The controller 57 transmits the selected file or files to the record and playback device 1′ (step K5). In example, only the bookmark file 112₁ is transmitted.

The record and playback device 1′ stores the file or files in storage 19′ (step L3).

The user may request playback of extracted content or still-to-be-extracted content. The request may request playback of extracted content using the mobile terminal 8 (step K6). Thus, the controller 57 transmits an instruction to playback extracted content to the record and playback device 1′. Alternatively, the user may request playback using remote control device 6′.

The CPU 17′ checks whether it has received a request to play back extracted content (step L4).

When the CPU 17′ is instructed to play back extracted content, it checks whether it received the appropriate extracted content file corresponding to the bookmark file (step L5). If so, it can proceed by playing back the extracted content file (step L6). If not, the CPU 17′ checks whether it has received the appropriate playback file (step L7). In this case, the appropriate playback file is playback file 95.

If the appropriate playback file has not been received, the CPU 17′ checks whether it has a playback file with the appropriate content (step L8). If not, then the record and playback device 1′ cannot as yet extract and render the bookmarked content.

If the record and playback device 1′ has the appropriate playback file or a playback file with the appropriate content, whether it be received from the mobile terminal 8 or other otherwise, the CPU 17′ synchronises the playback file with the bookmark file (step L9), creates an extracted content file (step L10), plays back the extracted content (step L11) and saves the extracted content file in storage 19′ (step L12).

It will be appreciated that many modifications may be made to the embodiments hereinbefore described. For example, the content may comply additionally or alternatively to other standards. The content may be encoded or encrypted.

What is claimed is:

1-65. (canceled)

66. A device comprising:
a user interface;
a network interface;
a processor; and
storage,
the processor being configured to bookmark digital content in response to user input, to store at least one bookmark in storage and to transmit at least one bookmark to another device via the network interface.

67. A device according to claim 66, wherein the processor is configured to identify the user.

68. A device according to claim 67, wherein the user interface comprises an interface for establishing connection with the other device via a wireless network and the processor is configured to identify the user at least in part by an authentication procedure employed to establish the connection.

69. A device according to claim 67, wherein the processor is configured to store said at least one bookmark in a bookmark file associated with the identified user.

70. A device according to claim 66, wherein the processor is configured to store at least one bookmark associated with a point within said content.

71. A device according to claim 66, wherein the processor is configured to store respective bookmarks associated with two or more points within said content.

72. A device according to claim 71, wherein first and second bookmarks mark a beginning and end of a segment of content respectively.

73. A device according to claim 66, wherein the processor is configured to bookmark said content in response to user input and to store a set of bookmarks.

74. A device according to claim 73, wherein the processor is configured to store the content in a content file and to obtain extracted content from the content file in dependence upon the set of bookmarks.

75. A device according to claim 74, wherein said extracted content is selectively accessible according to the identity of the user.

76. A device according to claim 74, wherein said processor is configured to transmit said extracted content file to another device.

77. A device according to claim 76, wherein the network interface is a wireless network interface and said processor is configured to transmit said extracted content file to another device via a wireless network.

78. A device according to claim 66, wherein said at least one bookmark is editable.

79. A device according to claim 66, wherein the network interface comprises an interface for wirelessly communicating with said other device.

80. A device according to claim 66, wherein the device comprises at least two processors.

81. A device according to claim 66, further comprising:
a digital broadcast network interface.

82. A digital broadcast receiver comprising the device according to claim 66.

83. A device according to claim 66, wherein the at least one bookmark comprises a pointer to within said content.

84. A device according to claim 66, wherein the at least one bookmark comprises data added to a file storing said content.

85. A device according to claim 66, wherein the at least one bookmark comprises data added to a file other than a file storing said content.

86. A device comprising:
a user interface;
a network interface; and
a processor;
the processor being configured to bookmark content in response to user input and to provide at least one bookmark, to extract content in dependence upon said at least one bookmark and to transmit said extracted content.

87. A device comprising:
a network interface; and
a processor;
the processor configured to receive digital content and to receive a set of bookmarks relating to said digital content from another device via the network interface and to selectively output parts of said digital content for rendering in dependence said set of bookmarks.

88. A device according to claim 87, further comprising a digital broadcast network interface, wherein the processor is configured to receive digital content from the digital broadcast network interface

89. A device according to claim 87, wherein said device is configured to receive said digital content and said set of bookmarks relating to said digital content from the same device.

90. A device according to claim 87, wherein the digital content is stored in a content file and the processor is configured to obtain a set of extracted content from content file in dependence upon said set of bookmarks.

91. A device according to claim 87, which is a mobile communications device.

92. A device according to claim 87, which is a device for storing and playing back digital content.

93. A device according to claim 87, wherein the network interface is an interface for wirelessly communicating with said other device.

94. A device according to claim 87 which is a portable wireless device configured to co-operate wirelessly with a terminal for receiving digital broadcast content, the device configured to identify a user to the terminal and to transmit instructions to the terminal to bookmark digital content

95. A device comprising:
a network interface; and
a processor;
the processor configured to receive a file of digital content and a file of bookmarks relating to said digital content, to extract selected digital content in dependence said bookmarks and to save extracted content in file of extracted content

96. A method comprising:
playing digital broadcast content;
receiving user input;
bookmarking the content in response to the user input storing at least one bookmark; and
transmitting said bookmark to another device.

97. A computer readable medium storing a computer program comprising instruction which, when executed by a data processing device, causes the data processing device to perform a method according to claim 96.

98. A method comprising:
receiving digital content;
receiving a set of bookmarks relating to said digital content;
selectively rendering said digital content in dependence said set of bookmarks.

99. A method according to claim 98, further comprising:
obtaining extracted content from digital content in dependence upon said set of bookmarks and saving said extracted content in a file.

100. A computer readable medium storing a computer comprising instructions which, when executed by a device for storing and playing digital content, performs a method according to claim 98.
